(19) United States
(12) Patent Application Publication
(10) Pub. No.: US 2008/0091583 A1
(43) Pub. Date: Apr. 17, 2008

(54) METHOD FOR GENERATING RULE-BASED ACTIVE FUTURES SELECTION INDICES

(75) Inventors: Gary Gorton, Haverford, PA (US); Geert Rouwenhorst, New Haven, CT (US); Fumio Hayashi, Tokyo (JP)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: American International Group, Inc., New York, NY (US)

(21) Appl. No.: 11/862,658

(22) Filed: Sep. 27, 2007

Related U.S. Application Data
(60) Provisional application No. 60/827,173, filed on Sep. 27, 2006.

(51) Int. Cl. G06Q 40/00

(52) U.S. Cl. 705/36 R

(57) ABSTRACT

A method for generating a futures index based on active, rule-based analysis of at least two commodities futures is disclosed. The method can include identifying which commodity futures to include in a set under analysis. A parameter can be selected to measure a signal of future expected risk premium of each commodity future of the set. The signal for each commodity future of the set can be calculated. The set of commodity futures can be ranked relative to each other according to the value of the signal for each commodity future. A predetermined rule can be applied to each commodity future in the set to determine whether a position is taken in each commodity future, the determination depending on its ranking.

### CROSS-REFERENCE TO RELATED APPLICATIONS

This patent application claims the benefit of priority to U.S. Provisional Patent Application No. 60/827,173, filed Sep. 27, 2006, and entitled “Method for Generating Rule-Based Active Futures Selection Indices,” which is incorporated in its entirety herein by this reference.

### FIELD OF THE INVENTION

This invention pertains to a method of generating futures selection indices, and more particularly to a method for generating rule-based, active futures selection indices.

### BACKGROUND OF THE INVENTION

In general, an index is a statistical measure of prices or returns in a financial market. In particular, an index is an imaginary portfolio of securities or assets representing a particular market or a portion of it. Each index has its own calculation methodology and is expressed in terms of a change from a base value.

Based on the index, investors can develop different strategies for investing in futures such as investing “long” or “short” in futures contracts. Taking a long position, or going long, in an asset or derivative means the buying of an asset or derivative, such as, a stock, a commodity future or a currency, for example, with the expectation that the asset or derivative will rise in value. On the other hand, taking a short position, or going short, in an asset or derivative refers to the sale of a borrowed security, or to the sale of a commodity future or currency with the expectation that the asset or derivative will fall in value. For example, an investor who borrows shares of stock from a broker and sells them on the open market is said to have a short position in the stock. The investor must eventually return the borrowed stock by buying it back from the open market. If the stock falls in price, the investor buys it for less than he or she sold it, thus making a profit.

In the case of a commodity futures index, its value can be based on several factors, including the percentage of the commodity in the index and the change in the price of the commodity future during a predetermined time period. Futures indices are economically significant because they provide diversification and provide liquidity. Moreover, such indices can potentially produce high rates of return from year to year.

The investment opportunity set in financial instruments is wider than most investors have available to them. In particular, retail and institutional investors have difficulty investing in commodity futures generally, and in active commodity futures strategies more specifically. Commodity futures are derivative contracts. Investing in derivative instruments requires more sophistication than investing in traditional cash instruments, such as stocks or bonds. Because commodity futures typically have short maturities, the investor must frequently close out positions that are near maturity and open new positions, a process known as “rolling.”

The barriers to entry in commodity futures are unfortunate. Commodity futures are a valuable asset class for investors. For example, the excess return on this asset class has historically been similar to that on equities, but commodity futures, as an asset class, have not been riskier than equities. Moreover, the returns of commodity futures (as an asset class) have been negatively correlated with stocks and bonds but have been positively correlated with inflation.

In response to these problems, financial firms have developed commercial commodity futures indices. These indices are passive indices that provide exposure to fixed baskets or portfolios of commodity futures. The index providers or their licensees may trade the underlying commodity futures, hedging the risk, to provide the exposure for investors. Unlike other asset classes, such as equities or corporate bonds, there does not exist a wide variety of investment strategies in commodity futures indexes. Commodity Trading Advisors (CTAs), which register with the Commodity Futures Trading Commission, are an alternative for institutional investors, but these discretionary funds may have significant fees and expenses.

Thus, there is a need for more robust indices and investment strategies that allow investors affordably to take advantage of commodity futures.

### SUMMARY OF THE INVENTION

The inventors have developed new commodity futures indices that are active and rules-based. The composition of the indices, with respect to the constituent commodity futures, generated by the present method changes as a function of at least one observed market signal, which reflect the underlying fundamentals of commodity futures as predicted by economic theory. An index generated according to the present invention would have demonstrably outperformed traditional, passive commodity futures indices, based on simulated historical results.

The new indices are based on measures of certain market price data on an individual commodity futures basis. The market price measures provide signals indicating when the risk premia on particular commodities are expected to be higher. The selected universe of commodity futures is sorted, based on the signals, into one or more portfolios, such as long or short portfolios.

In one method for generating a futures selection index, a set of commodity futures is selected, the set of commodity futures is sorted based on at least one economic signal, the set of commodity futures is ranked based on the at least one economic signal, and a rule is applied to place the set of commodity futures into one or more portfolios.

For example, an embodiment of the method of the invention can sort a set of commodities using their relative basis as the measured economic signal and provide a long-only index based on the sorted commodity by applying a long-only rule. The basis for a given commodity is the percentage difference between the current futures price of the two nearest-to-maturity contracts annualized using the number of days between expiration of these contracts. With the long-only rule, only commodities with a high basis are used in the index. For example, in a set of nineteen commodities, the nine commodities having the nine highest relative bases can be selected for the long-only index. The basis can be measured periodically, for example at the end of each month, so that the index can be re-balanced to reflect current situations in the futures commodities market. In other embodiments, the measurement period can be another amount of time, such as weekly, bimonthly, quarterly, etc.

In another embodiment of the invention, a long-short rule can be applied to provide a long-short index based on sorting on the basis at the end of each month. This index also uses the basis as a signal, and goes long the high basis commodity futures and short the low basis commodities. For example, in a set of nineteen commodities, the nine commodities having the nine highest relative bases can be selected for a long position and the nine commodities having the nine lowest relative bases can be selected for a short position, with the index taking no position in the futures commodity occupying the middle position between the highest and lowest basis (i.e., the tenth ranked highest and lowest basis).

In yet another embodiment of the invention, a long-only index can be generated by measuring the relative price momentum of each commodity in the selected set of commodities over a predetermined period of time. The momentum measures the commodity's amount of excess return over, for example, the past twelve months. The index can be composed only of high momentum commodities by applying a long-only rule. Again, the long-only index generated by measuring momentum can be re-balanced by measuring the momentum signals periodically, for example every month. In other embodiments, other past horizons are also possible.

In still another embodiment of the invention, a long-short index can be generated by measuring relative momentum of the selected commodities and applying a long-short rule. In other embodiments of the invention, the rule applied to the measured commodities can vary.

The state of current inventories of a commodity has implications for the risk premium in that commodity's futures. The state of inventories relative to normal is signaled by the basis, which contains information about the risk premium because lower inventories mean more spot price risk in the future. A low inventory state persists because production takes time. Consequently, there is persistence in the risk premium. This can be detected using past returns (i.e., their momentum), which persist until inventories are replenished back to the normal level. The indices constructed above are based on these observations. The back testing confirms the economic theory.

The Sharpe ratios on the new indices make them very attractive investment opportunities. This is especially true when compared to CTAs. CTAs may charge significant fees for their services, but, relative to the indices in the present invention, CTAs may not add value, even taking account of the trading costs for the new indices.

The features of the present invention will become apparent to one of ordinary skill in the art upon reading the detailed description, in conjunction with the accompanying drawings, provided herein.

### BRIEF DESCRIPTION OF THE DRAWINGS

FIG. 1 is a flowchart depicting an embodiment of a method for creating a commodity index according to the present invention.

FIG. 2 is an illustration of a method of calculating the basis, or “trader's backwardation,” of a commodity suitable for use in the present invention to rank a commodity in the index.

FIG. 3 is a graph of the return from Jan. 2, 1991, to Jun. 30, 2006, of a traditional index, the DJ-AIGCITR index; an index generated according to a method of the present invention for generating a futures index using each commodity's basis as a measuring signal, the basis index; and an index generated according to a method of the present invention for generating a futures index using each commodity's momentum as a measuring signal, the momentum index. All data for the DJ-AIGCITR index prior to index launch on Jul. 14, 1998, is an historical estimation using available data.

FIG. 4 is a graph of annualized returns for the one, three, five, and ten year periods and since Jan. 2, 1991, ending Jun. 30, 2006, for the DJ-AIGCITR, the momentum, and the basis indices of FIG. 3.

FIG. 5 is a graph of quarterly returns for the DJ-AIGCITR, the momentum, and the basis indices of FIG. 3 for the period from Jan. 2, 1991, to Jun. 30, 2006.

FIG. 6 is a graph of the annualized volatility of the monthly returns for the DJ-AIGCITR, the momentum, and the basis indices of FIG. 3 for the period from Jan. 2, 1991, to Jun. 30, 2006.

FIG. 7 is a graph of the returns from Jan. 2, 1991, to Mar. 31, 2006, of a traditional commodity index and a futures commodity index generated according to a method of the present invention wherein the basis and the momentum indices of FIG. 3 are combined together in equal portions and re-balanced monthly.

FIG. 8 is a graph showing the annualized returns for the one, three, five, and ten year periods and since Jan. 2, 1991, ending Jun. 30, 2006, of the traditional commodity index and the combined index of FIG. 7.

FIG. 9 is a graph of the quarterly returns of the combined index of FIG. 7 less those of the traditional index of FIG. 7 from Jan. 2, 1991, and ending Jun. 30, 2006.

FIG. 10 is a graph of the annualized volatility of monthly returns for the period from Jan. 2, 1991, to Jun. 30, 2006, for the traditional commodity index and the combined index of FIG. 7.

FIG. 11 is a graph of the annual returns from Jan. 2, 1991, to Jun. 30, 2005, of the traditional commodity index; an index generated according to a method of generating a futures index using each commodity's basis as a measuring signal and applying a rule wherein the index goes long in the nine commodities exhibiting the highest basis, goes short in the nine commodities exhibiting the lowest basis, and takes no position in the remaining commodities; and an index according to a method of the present invention wherein the traditional commodity index and the short/long basis index are combined together in equal portions.

FIG. 12 is a graph showing the annual returns of the indices of FIG. 11 for the period from Jan. 2, 1991, to Jun. 30, 2005.

FIG. 13 is a graph of the quarterly returns of the long/short basis index of FIG. 11 for the period from Jan. 2, 1991, to Jun. 30, 2005.

FIG. 14 is a graph of the annualized volatility of monthly returns for the indices of FIG. 11 for the period from Jan. 2, 1991, to Jun. 30, 2005.

FIG. 15a-k is a first specimen of an embodiment of a swap transaction confirmation relating to a long-short index generated using a method according to the present invention wherein the basis of each commodity in the set of identified commodities is measured to rank the commodities.

FIG. 16a-h is a second specimen of another embodiment of a swap transaction confirmation relating to a long-short index generated using a method according to the present invention wherein the momentum of each commodity in the set of identified commodities is measured to rank the commodities.

### DETAILED DESCRIPTION OF THE INVENTION

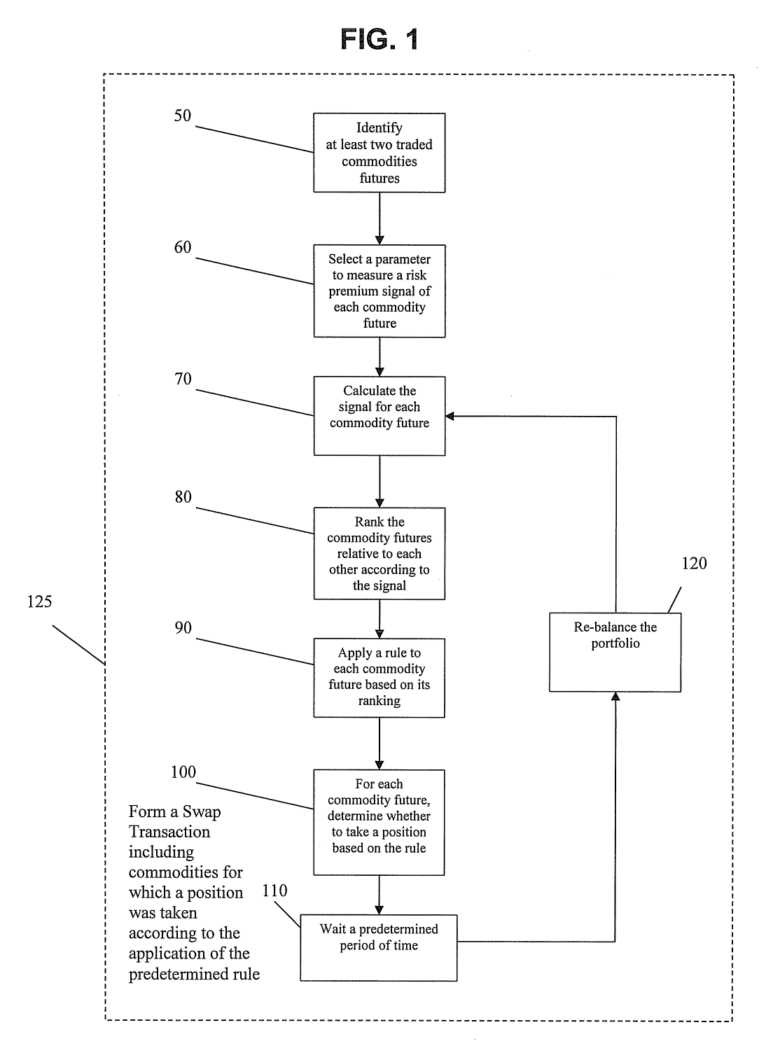

The method according to the present invention can comprise a method for generating a commodities futures index based on active, rules-based analysis of a set of at least two futures commodities. Referring to FIG. 1, the method can include a step 50 of identifying which commodities to include in the set under analysis. The identification step 50 can be used to identify at least two such commodity futures. In some embodiments, the step 50 of identifying commodity futures for inclusion into the set of commodities to be analyzed can be used to identify longer maturity contracts, rather than the nearest-to-maturity contract.

The method can include a step 60 of selecting a parameter to measure the risk premium signal of each commodity of the set. The risk premium signal for each commodity of the set can be calculated in another step 70. In some embodiments of the invention, the parameter under analysis can be the basis of the commodity. The basis of the commodity future can be calculated as follows:
(F1/F2−1)*365/(D2−D1),

where F1 is the price of the nearest futures contract,

F2 is the price of the next nearest futures contract, and

D1 and D2 are the number of days until expiration of the respective contracts.

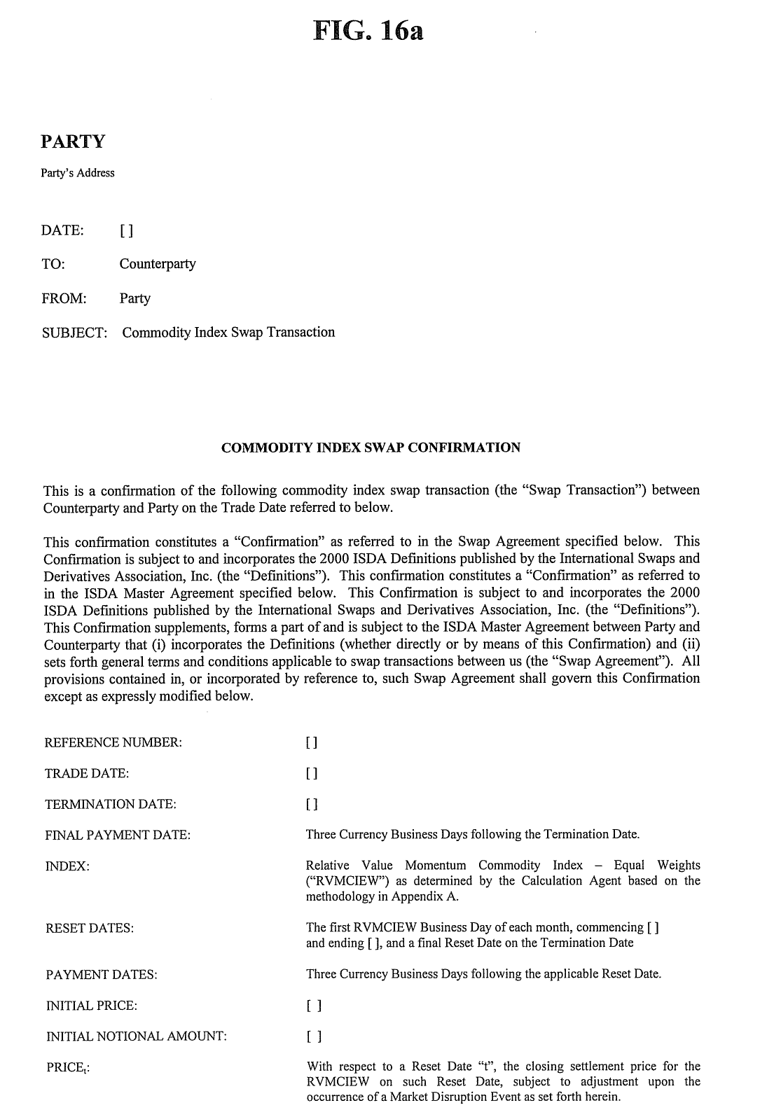

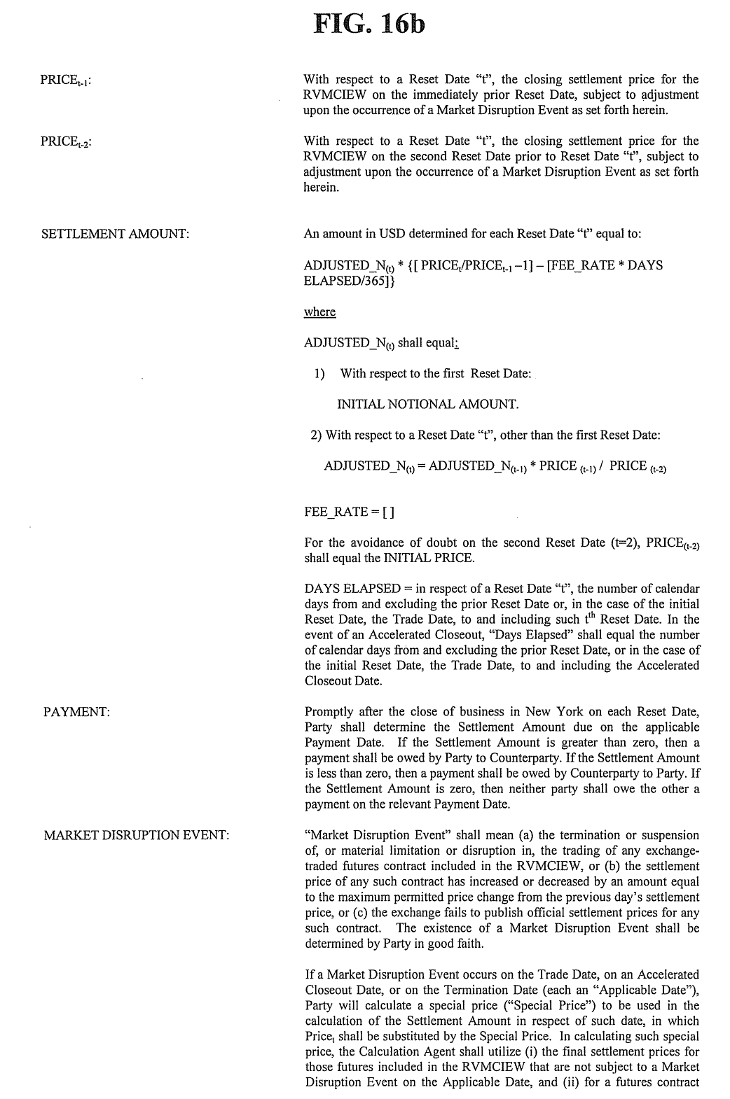

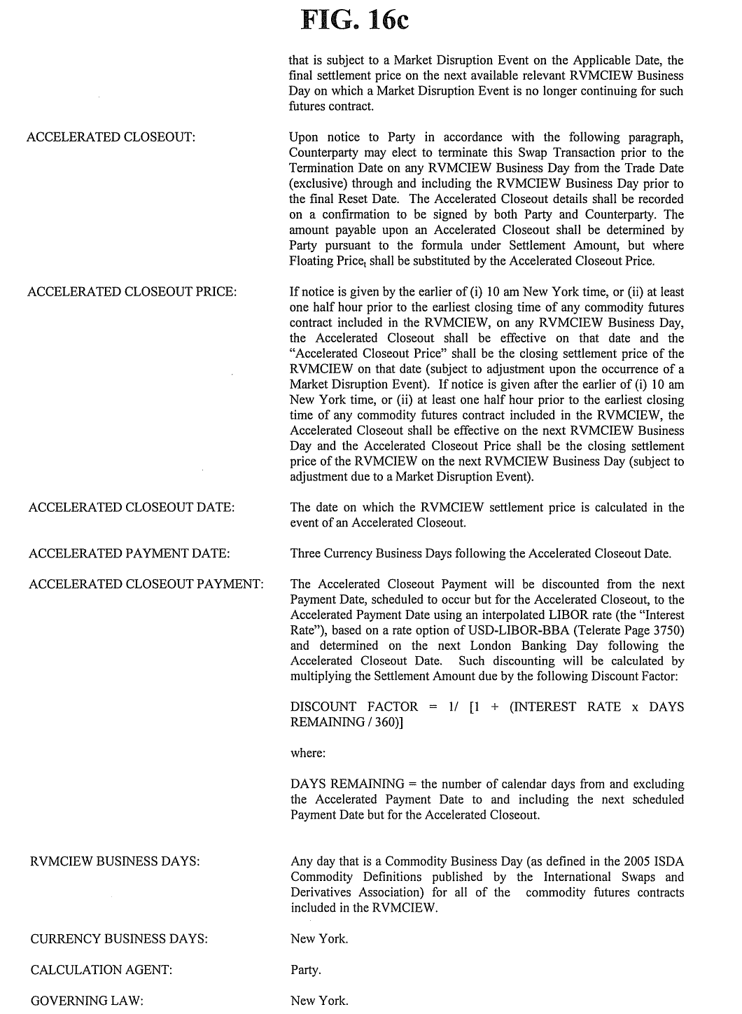

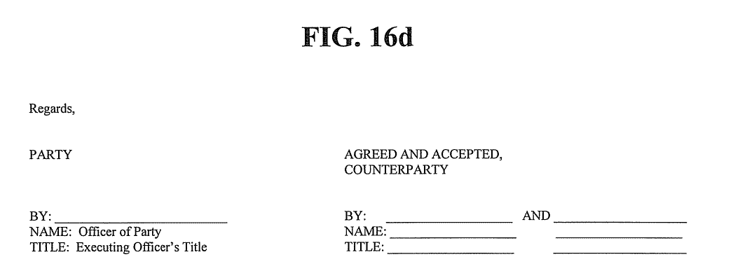

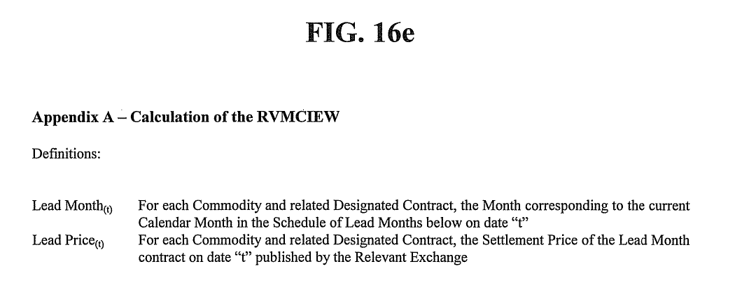

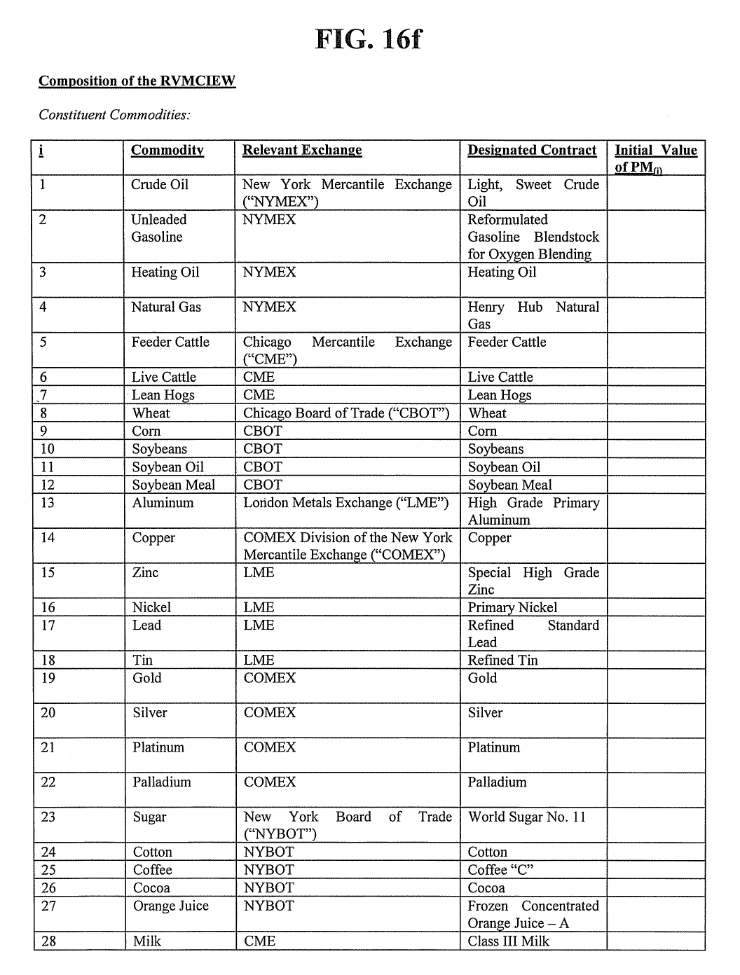

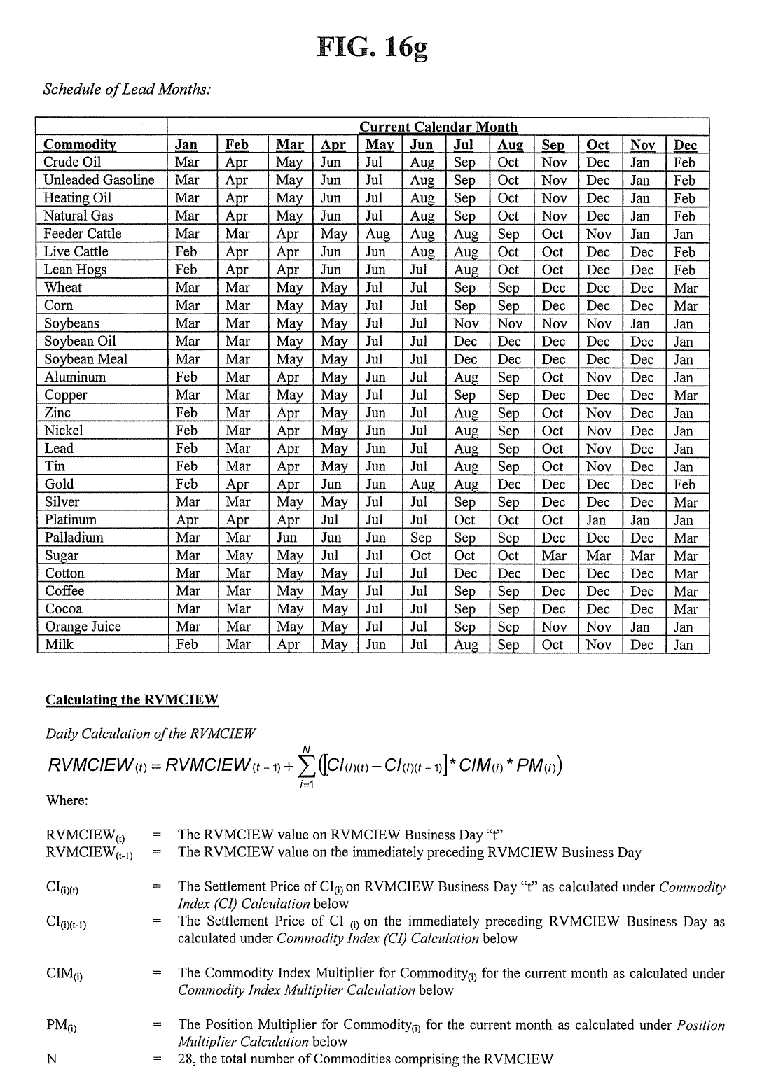

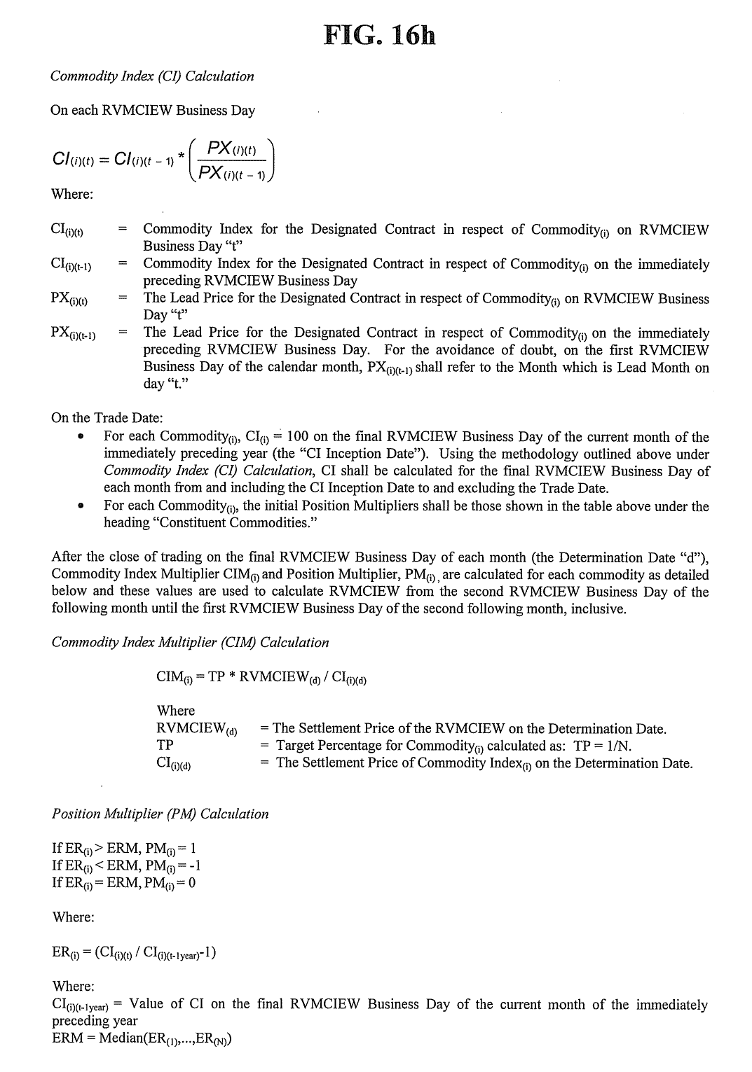

In yet other embodiments of the invention, the parameter under analysis can be the momentum of the commodity. An example of a formula for calculating the momentum of a commodity future is found in Appendix A of FIG. 16.

The method can include a step 80 of ranking the set of commodities relative to each other according to the value of the parameter for each commodity. In another step 90, a predetermined rule can be applied to each commodity in the set to determine (step 100) whether a position is taken in each commodity and to take a position in each commodity depending on its ranking and the rule so applied.

The index generated by the method of the present invention can be re-balanced by re-sorting the commodities in the set under analysis after a predetermined amount of time (step 110), one month for example, has elapsed. A rebalancing step 120 can be accomplished by repeating the calculating step 70, the ranking step 80, the rule applying step 90, and the position-taking step 100. Along with re-sorting on a periodic basis, the composition of the indices can also change with each re-sorting. In other embodiments, the amount of time can vary, such as weekly, bi-weekly, bi-monthly, quarterly, etc.

The method for generating a commodities futures index can be used in a swap transaction by forming (step 125) a swap transaction including commodity futures for which a position was taken in the position-taking step 100 according to the application of the predetermined rule in the rule applying step 90. The swap transaction can include a description of the steps 50, 60, 70, 80, 90, 100, 110, 120 used to generate the index.

In some embodiments, a weighting factor can be attributed to one or more of the commodities of the set such that when the weighted commodity is selected according to the particular rule applied for taking a position, that particular commodity will be purchased in a different amount than at least one other commodity also selected for taking a position according to the rule applied. For example, the method according to the present invention can use DJAIG weights or can be equally-weighted.

Modified-Roll can be added to an index generated by the present invention based on DJAIGCI weights. Because futures contracts have specified maturities that are short, usually less than two years, it is necessary for long-horizon investors to “roll” their futures positions. This means they must sell short maturity contracts just prior to maturity and buy longer maturity contracts. The large commercial passive indices roll on the days five through nine of each month. “Modified-Roll” refers to altering the dates at which futures roll, so that the roll dates does not occur on days five through nine. An equally-weighted index generated by the present invention need not roll on the DJAIGCI roll dates.

In one aspect of the invention, a rule is applied that selects only a predetermined number of the commodities having the highest basis relative to each other to generate a long-only index. In one embodiment, the commodities are sorted on their basis at the end of each month. The basis is the percentage difference between the current futures price of the two nearest-to-maturity contracts annualized using the number of days between expiration of these contracts. With the commodities sorted by their relative ranking, a long position is taken in a predetermined number of those having the highest ranking.

In yet other embodiments, a long-short index can be generated by the method of the present invention based on sorting on the basis at the end of each month. This index also uses the basis as a signal, and goes long on a predetermined number of commodity futures having the highest basis and goes short on a predetermined number of commodity futures having the lowest basis. In some embodiments, the rule for determining in which commodity futures to take a position, can include a different number of long commodity futures than short commodity futures.

In yet other embodiments of the invention, the method can use momentum as the signal which is measured in order to generate a long-only index. The method can sort the selected commodity futures based on their momentum, defined as the excess return over past 12 months, relative to each other. The method can apply a rule that selects only a predetermined number of those commodity futures having the highest momentum.

In still other embodiments of the invention, a method for generating a futures index can generate a long-short index based on sorting on past returns (i.e., momentum). This index also uses each commodity future's relative momentum as a signal to compare, and goes long on a predetermined number of commodity futures having the highest momentum and goes short on a predetermined number of commodity futures having the lowest momentum.

The Economic Rationale for Sorting on the Basis and on Momentum: What is the economic logic justifying the above indices? Without limiting the inventions in any way, the inventors believe that the following economic rationale explains why indices generated by the present invention can outperform passive indices of the prior art.

The fundamentals of commodity futures are inventory and production dynamics. Economic agents who hold inventories of commodities must decide whether to sell their goods at today's spot price or store some of their goods to be sold in the future at the expected future spot price. The new indices are grounded in the link between inventory movements and the risk borne by long futures investors.

A few key points have been made (in the economics literature) about the aggregate decision process of inventory holders for a given commodity. First, inventory holders can carry goods forward to the future, but they cannot bring future goods (that have not been produced yet) back to the present. Second, if inventory holders carry fewer goods over to the future, then the volatility of the future spot price will be higher. Intuitively, there are fewer goods in the future to buffer any unexpectedly high demands for the goods. Thirdly, goods cannot be instantaneously produced, so if inventory levels decline (due to high current demand), it can take awhile for inventories to be replenished.

These three points have implications for commodity futures risk premia. Imagine a situation where current demand for a commodity exceeds current supply due to either a spike in demand or a disruption in current supply. For supply to equate to demand there must be a high current spot price; that is, the price rises to allocate the existing commodities since goods cannot be brought from the future to meet the high current demand. Also in this situation inventory holders have an incentive to sell the commodity now rather than store it and sell it later, while consumers have an incentive to purchase it later, rather than purchase it now and store it, which means that the expected return from the second alternative must be lower than that from the first alternative. So, ignoring storage costs, the futures price must be below the current spot price resulting in “backwardation” (i.e., a high basis). Inventory levels decline as goods are sold, so less is carried over to the future. As a result of lower than normal commodity inventories, the variance of the expected future spot price increases. The variance of that expected future spot price is exactly the risk borne by long futures investors. So, they must receive higher compensation for bearing this risk and the risk premium, or excess return, earned (on average) by long investors in futures increases.

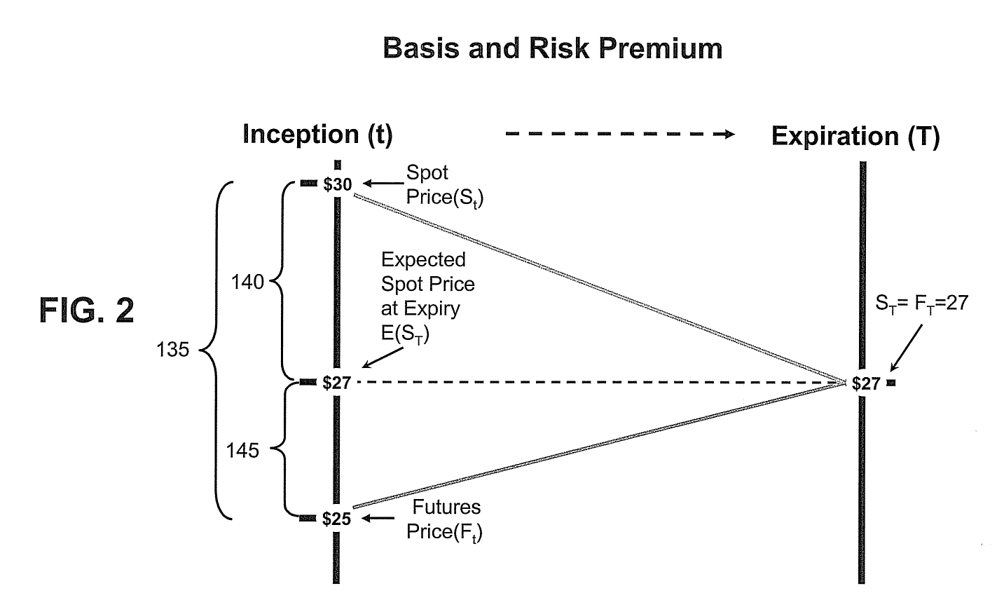

So, the effect of a supply or a demand shock, reducing inventories, is a high basis, i.e., the current spot price minus the current futures price is high (relative to normal). The basis contains information about the future risk premium. This can be seen by looking at the triangular diagram shown in FIG. 2. In FIG. 2, the basis, or “trader's backwardation,” is shown as the difference between the current spot price Sₜ and the current futures price Fₜ. As shown in the triangular diagram, the spot price Sₜ and the futures price Fₜ converge toward each other from inception t such that they are equal at expiration T. The figure illustrates that, by definition, the basis 135, i.e., Sₜ−Fₜ, consists of two components, the Expected Change in Spot Price 140, which is the difference between the current spot price Sₜ and the expected spot price at expiry E(S_{T}), plus the Expected Risk Premium 145, which is the difference between the expected spot price at expiry E(S_{T}) and the current futures price Fₜ. In other words, by adding and subtracting the expected future spot price E(S_{T}), we can write the basis 135 as:
Sₜ−Fₜ=Sₜ−E(S_{T})+(E(S_{T})−Fₜ).
In words, the Basis 135 is equal to the Expected Change in Spot Price 140 plus the Expected Risk Premium 145.

The Expected Change in Spot Price 140 is the expected appreciation or depreciation in the spot price. In the illustrative triangular diagram, the Expected Change in Spot Price 140 is $30−$27=$3, which indicates that market participants expect a $3 spot price fall between inception and expiration. The second term is the Expected Risk Premium 145, which in the illustrative triangular diagram is $27−$25=$2. An Expected Risk Premium 145 of two indicates that investors expect a $2 risk premium. Accordingly, the illustrative basis 135 is $3+$2=$5.

In reality we can observe the basis 135, and changes in the basis 135 over time. By definition a change in the basis 135 is composed of a change in the two right-hand side components: a change in the expected spot price 140, either as appreciation or depreciation, and a change in the expected risk premium 145. So, a change in the basis 135 potentially signals a change in the expected risk premium 145.

When the basis 135 changes we do not know for sure if there is a change in the expected risk premium 145, nor do we know by how much the risk premium 145 has changed. That is because, in reality, we cannot observe the expected future spot price S_{T} (=$27). But the argument above says that if the basis 135 increases, which we can observe and measure, then we may have a signal that the expected risk premium 145 is higher. This means that using the basis 135 as a signal we can find commodities that will have a risk premium 145 that is higher or lower than average. But, note that this is not an “arbitrage opportunity” because the reason the basis has increased, for example, is precisely because current inventories are low, causing future spot price risk to be higher. The increase in the basis reflects, in part, the higher risk premium that is compensation for that higher risk.

We noted above that an unexpected increase in demand that reduces inventories cannot be quickly reversed by increasing production (of course, how fast this happens depends on the commodity). That means that the lower than normal inventories will persist for some time and consequently that the higher than normal variance of future spot prices will persist. As a further consequence, the higher than normal risk premium will also persist, to compensate investors for that risk.

All of this adds up to the statement that there is momentum in commodity futures risk premia. In other words, conditional on a higher than normal excess return this month, next month's excess return will also be higher than normal. Thus, past returns are also a signal of higher future returns. This not an “arbitrage opportunity” because the higher returns are compensation for higher risk.

Note that the indices that select commodities using the basis as a signal, and those constructed using past returns (momentum) as a signal, are just two ways to find substantially the same information. Of course, there may be other reasons why each signal behaves as it does. Also, in some embodiments of the method of the present invention, the set of commodity futures can be double sorted such that both the relative momentum and the relative basis of each commodity future is calculated, and the set of commodity futures is sorted using both signals. In one embodiment, each commodity future of the set of commodity futures can be given a first ranking according to its relative basis and a second ranking according to its relative momentum. Each commodity future can be given an average ranking by taking the average of its first ranking and second ranking. Each commodity future can be sorted according to its average ranking.

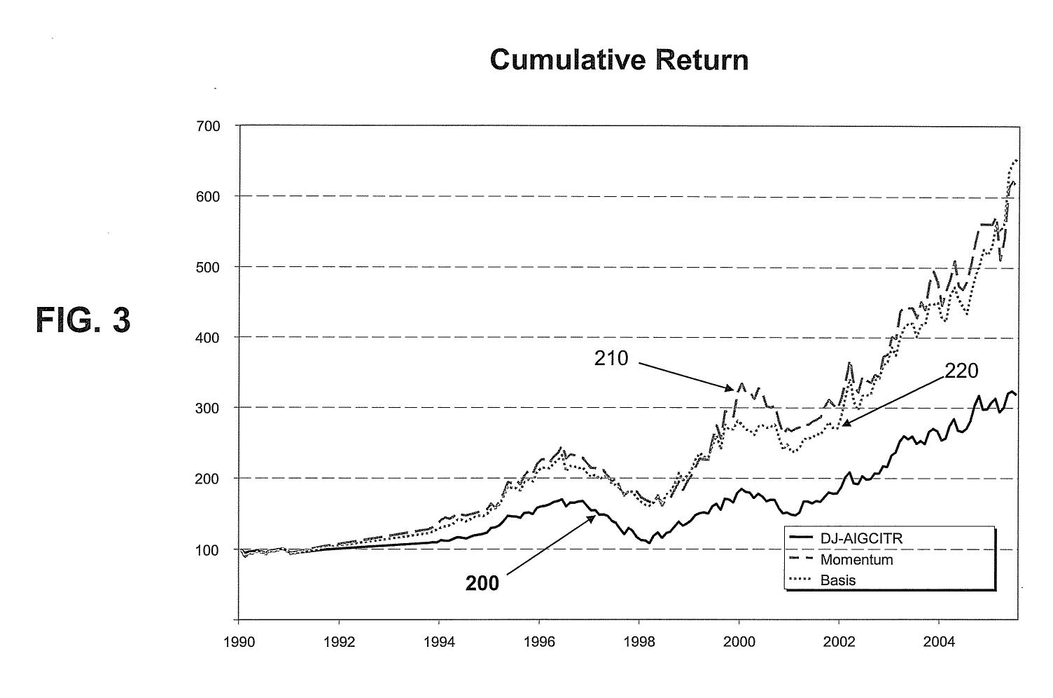

Back Testing Results: FIGS. 3-14 compare the performance of traditional indices with different embodiments of indices constructed according to the present invention. FIG. 3 is a graph comparing the cumulative return over a fifteen-year period from Jan. 2, 1991 to Jun. 30, 2006, for a prior index 200 against an index 210 generated according to the present invention using momentum as its signal (momentum) and against an index 220 generated according to the present invention using basis as its signal (basis). The prior index 200 selected in this instance is a Dow Jones-AIG Commodity Index^{SM} (DJ-AIGCI^{SM}) that is a total return index (DJ-AIGCITR^{SM}). All data for the momentum and basis indices 210, 220 represent historical estimations using available data.

The momentum index 210 can be generated by ranking the commodity futures in the DJ-AIGCI, for example, in order of momentum as measured by the previous twelve month return. The momentum for each commodity future can be calculated using the cumulative return for the immediately preceding twelve months. In other embodiments, one or more of the commodity futures in the DJ-AIGCI can be excluded from the set under evaluation. In yet other embodiments, additional commodity futures can be added to the set under evaluation. In one embodiment, the momentum index 210 applies a rule in which it goes long the nine commodity futures exhibiting the highest momentum and takes no position in the remaining commodity futures. The momentum index 210 can re-balance itself by ranking the commodity futures in order of their relative momentum once a month. In other embodiments, a different amount of time can be used between rebalancing.

The basis index 220 can be generated by ranking the commodity futures in the DJ-AIGCI, for example, in order of the basis. In one embodiment, the basis of each commodity future can be measured using the following formula:
(F1/F2−1)*365/(D2−D1)
where F1 is price of the nearest futures contract,
F2 is the price of next nearest futures contract,
D1 is the number of days until the expiration of the nearest futures contract F1, and
D2 is the number of days until the expiration of the next nearest futures contract F2.
   In other embodiments, one or more of the commodity futures in the DJ-AIGCI can be excluded from the set under evaluation. For example, in the basis index 220, gold and silver are excluded from the set under evaluation. In yet other embodiments, additional commodity futures can be added to the set under evaluation. The basis index 220 applies a rule in which it goes long in the eight commodity futures exhibiting the highest basis and takes no position in the remaining commodity futures. The basis index 220 can re-balance itself by ranking the commodity futures in order of their relative basis once a month. In other embodiments, a different amount of time can be used.

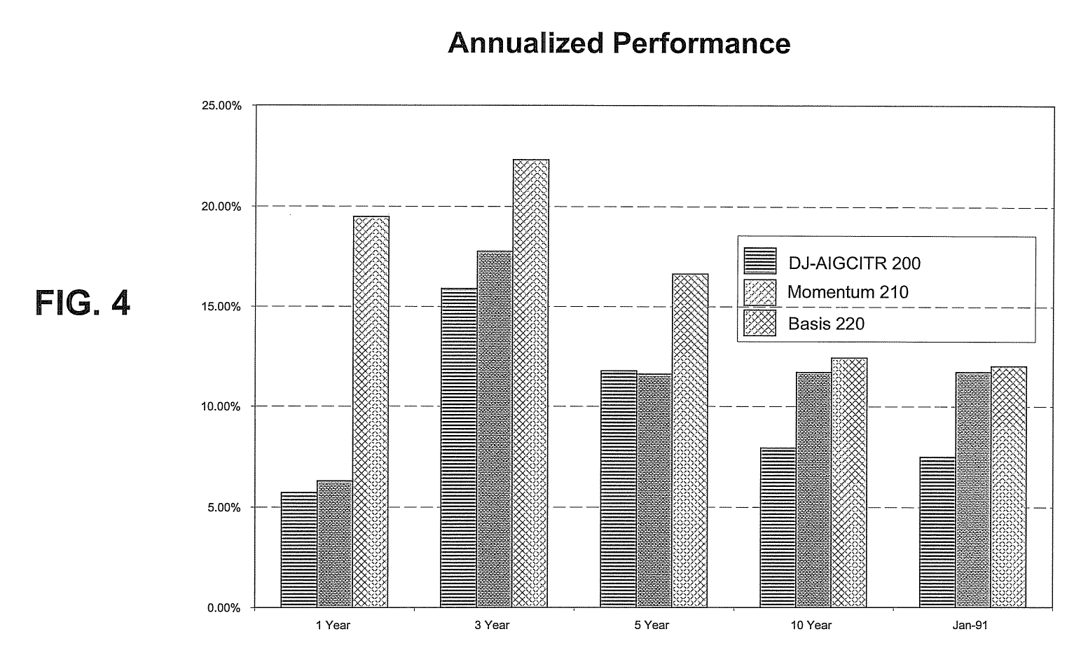

FIG. 4 is a chart showing the annualized performance of the DJ-AIGCITR index 200, the momentum index 210, and the basis index 220. FIG. 4 depicts annualized returns for the one, three, five, and ten year periods and for the period between Jan. 2, 1991, and Jun. 39, 2006, for the DJ-AIGCITR, momentum, and basis indices 200, 210, 220. FIG. 4 shows that the momentum and basis indices 210, 220 yielded higher returns for each time period with the exception of the five-year annualized return wherein the momentum index 210 had an annualized return that was slightly less than the DJ-AIGCITR index 200.

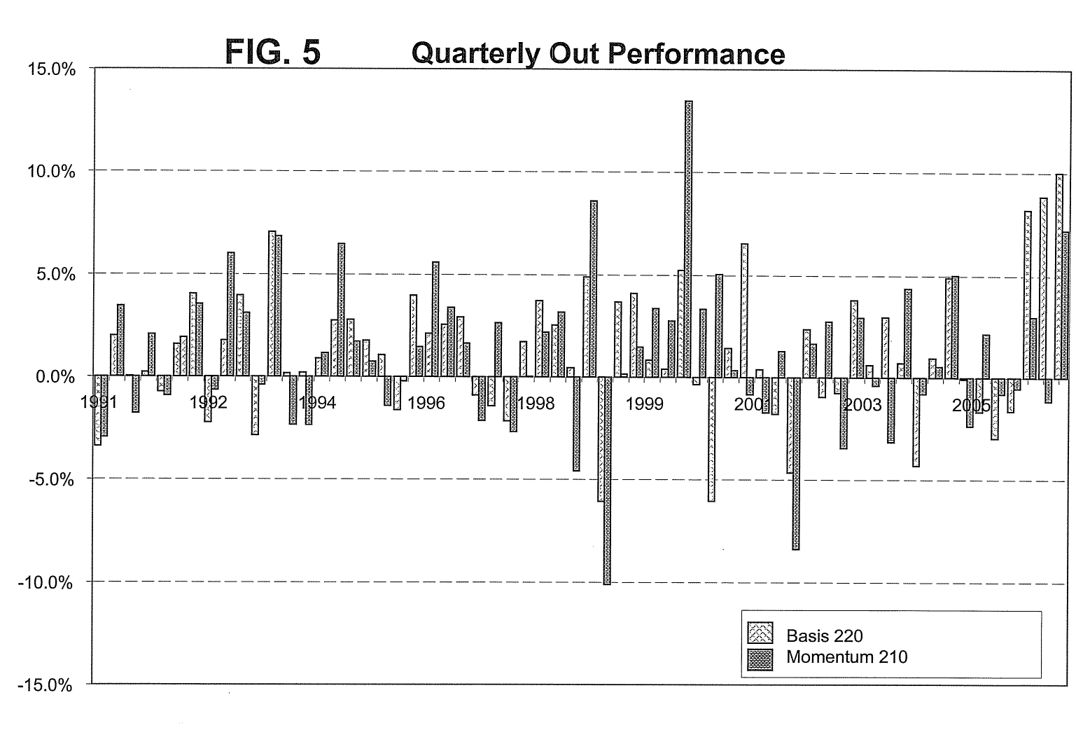

FIG. 5 is a chart showing the quarterly performance for both the momentum and basis indices 210, 220 less the performance of the traditional DJ-AIGCITR index 200. Of the sixty-two quarters charted in FIG. 5, the basis index 220 outperformed the traditional index forty-four times (reflected as a positive percentage performance) from 1991 to 2005. Similarly, the momentum index 210 outperformed the traditional DJ-AIGCITR index 200 thirty-eight times over the same time period.

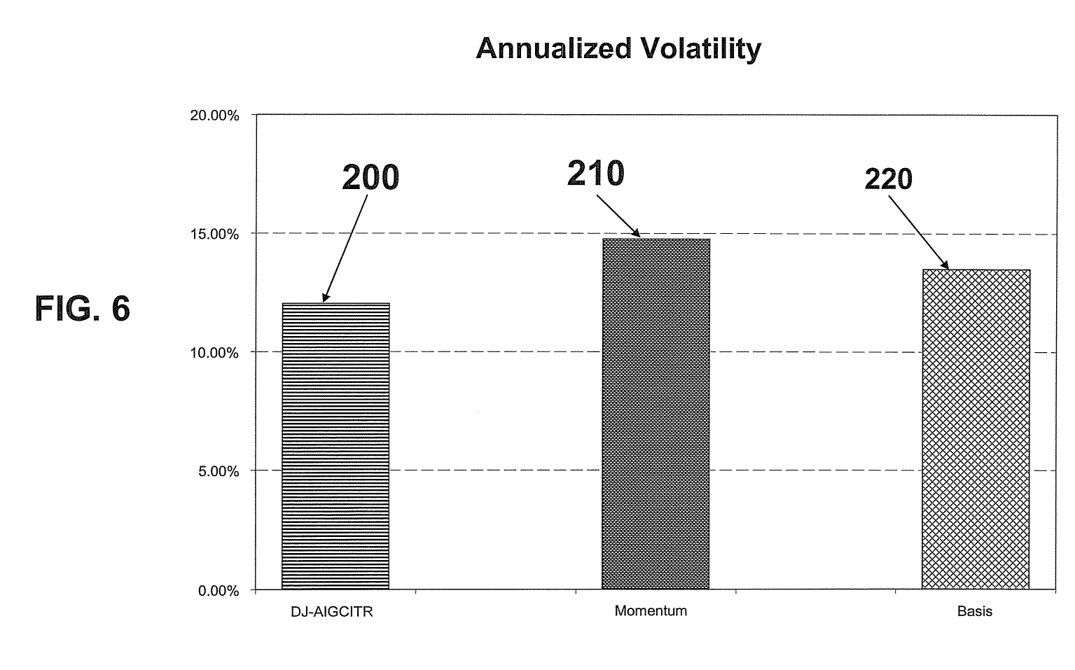

FIG. 6 is a chart of the annualized volatility of monthly returns of the traditional DJ-AIGCITR index 200, the momentum index 210, and the basis index 220. FIG. 6 shows that volatility of the momentum and basis indices 210, 220 was close to the volatility of the traditional DJ-AIGCITR index 200.

The table below, Table 1, sets forth the corresponding annualized returns, volatility, and Sharpe ratios for the DJ-AIGCITR, the momentum, and the basis indices 200, 210, 220 for the one, three, five, and ten year periods ending Jun. 30, 2006, and for the period between Jan. 2, 1991, and Jun. 30, 2006. The Sharpe ratio (or Sharpe index, Sharpe measure, or reward-to-variability ratio) is a measure of the mean return per unit of risk in an investment asset or a trading strategy. The Sharpe ratio can be computed as follows:

$$S = \frac{R - {R}_{f}}{σ}$$

where R is the asset return,
R_{f} is the return on a benchmark asset, such as the risk free rate of return,
R−R_{f} is the excess rate of return, and

σ is the standard deviation of the excess rate of return.

TABLE 1
annualized returns, volatilities, and Sharpe ratios for the DJ-AIGCITR, momentum,
and basis indices 200, 210, 220

| Index | Parameter | 1 Year | 3 Year | 5 Year | 10 Year | January 1991 |
|---|---|---|---|---|---|---|
| DJ-AIGCITR | Ann. Return | 18.11% | 17.21% | 13.73% | 8.12% | 7.77% |
| Momentum | Ann. Return | 27.91% | 21.88% | 15.26% | 12.06% | 12.42% |
| Basis | Ann. Return | 50.77% | 27.23% | 19.27% | 13.43% | 12.89% |
| DJ-AIGCITR | Volatility | 14.78% | 13.36% | 13.77% | 13.93% | 12.03% |
| Momentum | Volatility | 19.17% | 16.80% | 16.71% | 16.69% | 14.76% |
| Basis | Volatility | 13.76% | 13.31% | 14.77% | 15.01% | 13.48% |
| DJ-AIGCITR | Sharpe Ratio | 0.94 | 1.10 | 0.84 | 0.32 | 0.31 |
| Momentum | Sharpe Ratio | 1.24 | 1.15 | 0.78 | 0.50 | 0.57 |
| Basis | Sharpe Ratio | 3.38 | 1.86 | 1.16 | 0.65 | 0.66 |

Table 2 set forth below depicts the correlations of quarterly returns for the period from Jan. 2, 1991, to Jun. 30, 2006, of the DJ-AIGCITR, the momentum, and the basis indices 200, 210, 220 and the S&P Total Return Index and the Lehman Brothers Aggregate Bond Index against each other. Correlation is a statistical measure that tracks the way two securities move in relation to each other. If two securities are in perfect positive correlation (a value of +1.0), this indicates that as one security moves, either up or down, the other security will move in lockstep, in the same direction. If two securities are in perfect negative correlation (a value of −1.0), this indicates that if one security moves in either direction the security that is perfectly negatively correlated will move by an equal amount in the opposite direction. If the correlation between two securities is 0, the movements of the securities are said to have no correlation; they are completely random.

TABLE 2
Correlation of the DJ-AIGCITR, momentum, and basis indices
200, 210, 220 and the Lehman Brothers Aggregate Bond Index
and the S&P Total Return Index

| | | | | Lehman | |
|---|---|---|---|---|---|
| INDEX | DJ-AIGCI | Momentum | Basis | Aggregate | S&P 500 TR |
| DJ-AIGCI | 1.00 | 0.85 | 0.86 | (0.15) | (0.18) |
| Momentum | X | 1.00 | 0.87 | (0.08) | (0.16) |
| Basis | X | X | 1.00 | (0.08) | (0.18) |
| Lehman | X | X | X | 1.00 | (0.12) |
| Aggregate | | | | | |
| S&P 500 TR | X | X | X | X | 1.00 |

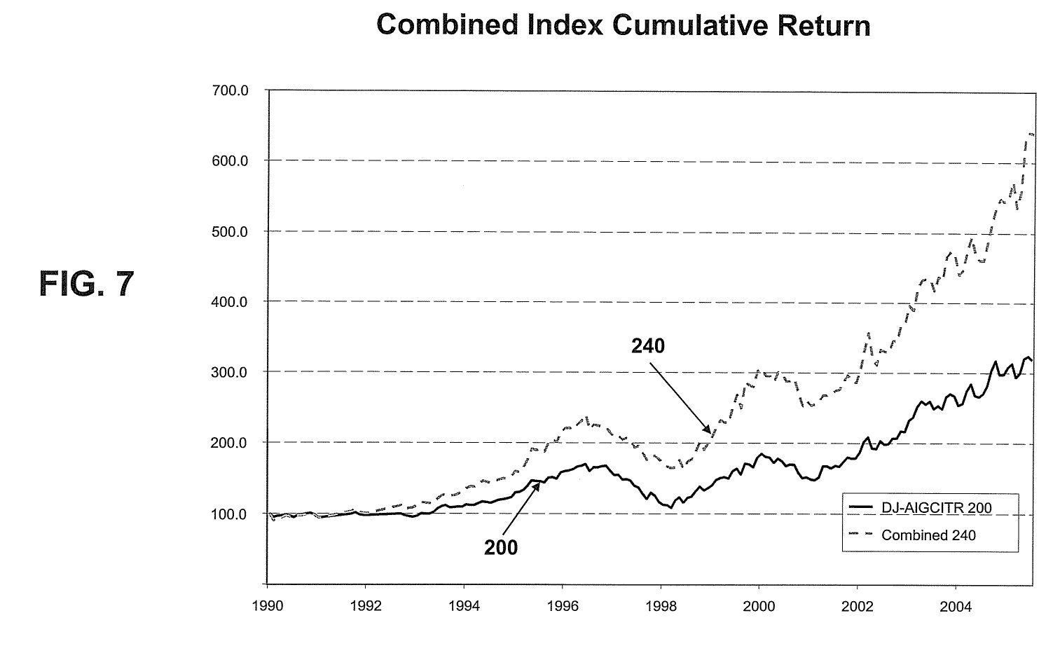

FIG. 7 is a graph comparing the cumulative return for the period from Jan. 2, 1991, to Mar. 31, 2006, for the DJ-AIGCITR index 200 against a combined index 240 generated according to the present invention that includes a first portion having as its index the momentum index 210 and a second portion having as its index the basis index 220. In this embodiment, the combined index 240 includes first and second parts with each comprising fifty percent of the total index. In other embodiments, the first and second parts can be weighted differently such that the first and second parts comprise different percentages of the total combined index. The combined index 240 is rebalanced monthly. In other embodiments, the combined index can be rebalanced using a different time period, such as bi-weekly, quarterly, semi-annually, etc. All data for the combined index 240 represents an historical estimation using available data.

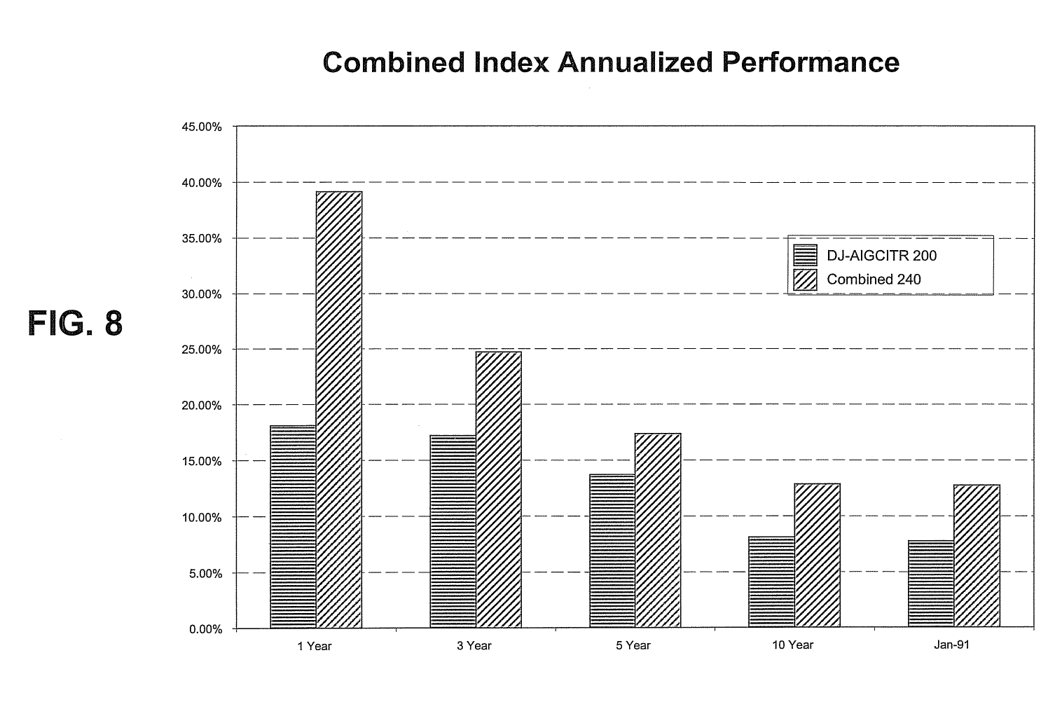

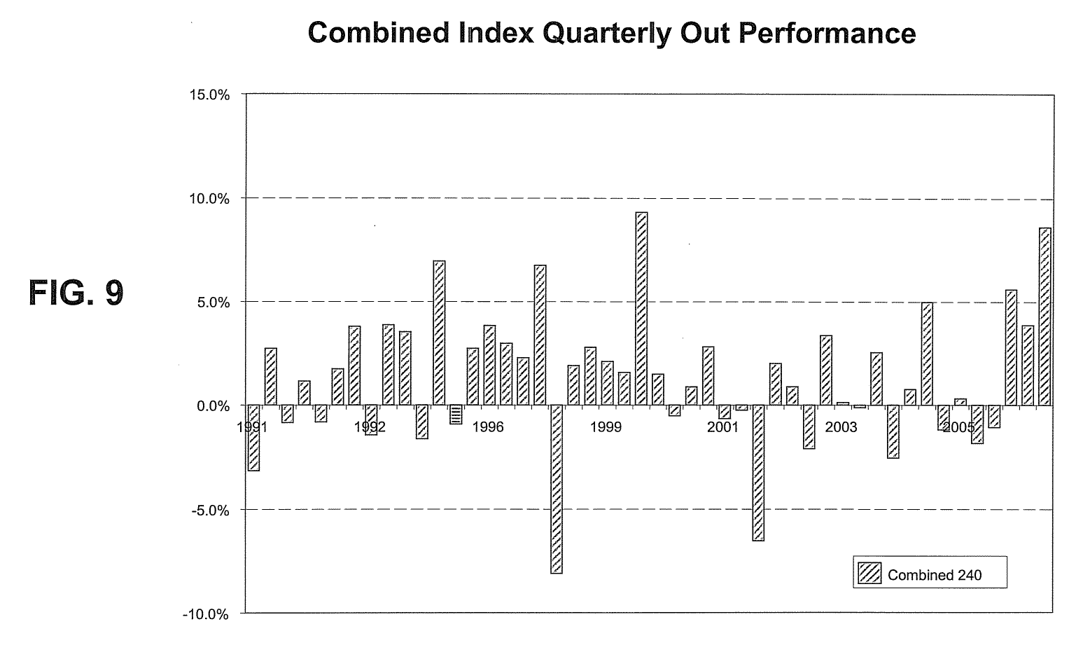

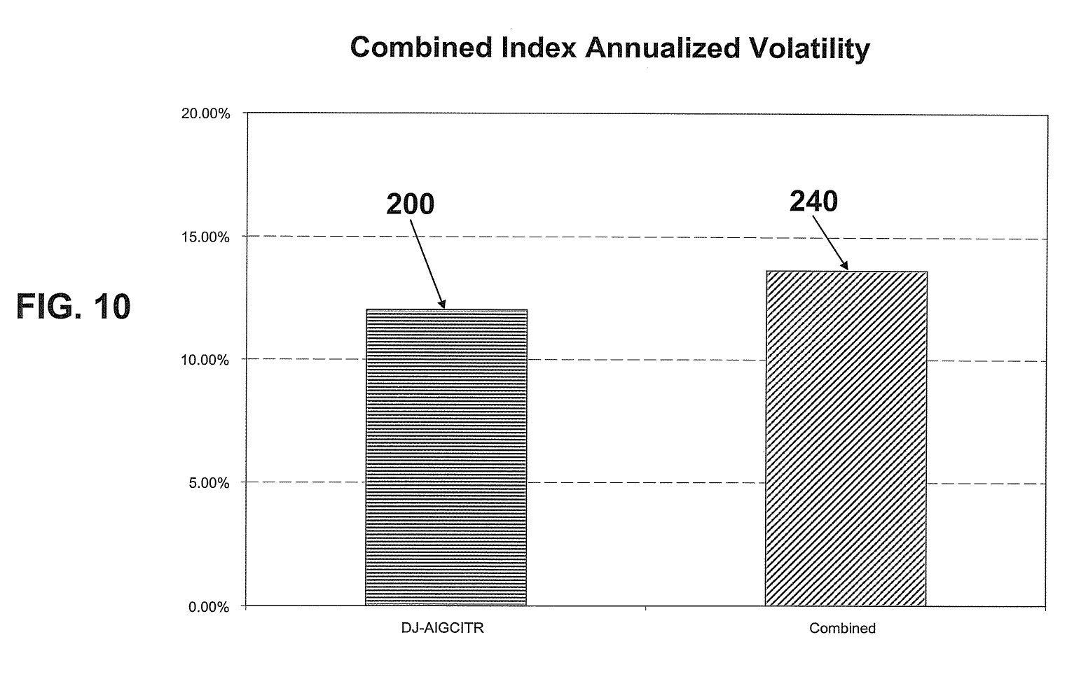

FIG. 8 is a chart comparing the annualized returns for the one, three, five and ten year periods and since Jan. 2, 1991, ending Jun. 30, 2006, for the DJ-AIGCITR index 200 and the combined index 240. FIG. 9 is a chart showing the Quarterly Return of the combined index 240 less the quarterly return of the traditional DJ-AIGCITR index 200 over a range of time between Jan. 2, 1991, and Jun. 30, 2006. The returns of the combined index 240 outperformed the traditional DJ-AIGCITR index 200 in over 60 percent of the quarters. FIG. 10 is a chart comparing the annualized volatility of monthly returns for the DJ-AIGCITR index 200 and the combined index 240 for the period from Jan. 2, 1991, to Jun. 30, 2006.

Table 3 sets forth the corresponding annualized returns, volatility, and Sharpe ratios for the DJ-AIGCITR and the combined indices 200, 240 for the one, three, five, and ten year periods ending Jun. 30, 2006, and for the period between Jan. 2, 1991, and Jun. 30, 2006.

TABLE 3
annualized returns, volatilities, and Sharpe ratios for the DJ-AIGCITR and combined
indices 200, 240

| Index | Parameter | 1 Year | 3 Year | 5 Year | 10 Year | January 1991 |
|---|---|---|---|---|---|---|
| DJ-AIGCITR | Ann. Return | 18.11% | 17.21% | 13.73% | 8.12% | 7.77% |
| Combined | Ann. Return | 39.14% | 24.70% | 17.37% | 12.84% | 12.73% |
| DJ-AIGCITR | Volatility | 14.78% | 13.36% | 13.77% | 13.93% | 12.03% |
| Combined | Volatility | 15.29% | 14.17% | 15.12% | 15.30% | 13.64% |
| DJ-AIGCITR | Sharpe Ratio | 0.94 | 1.10 | 0.84 | 0.32 | 0.31 |
| Combined | Sharpe Ratio | 2.28 | 1.57 | 1.00 | 0.60 | 0.64 |

Table 4 sets forth below the correlations of quarterly returns for the period from Jan. 2, 1991, to Jun. 30, 2006, of the DJ-AIGCITR and the combined indices 200, 240 and the S&P Total Return Index and the Lehman Brothers Aggregate Bond Index against each other.

TABLE 4
Correlation of the DJ-AIGCITR index 200, the combined index 240,
the Lehman Brothers Aggregate Bond Index, and the S&P
Total Return Index

| | | | Lehman | |
|---|---|---|---|---|
| INDEX | DJ-AIGCI | Combined | Aggregate | S&P 500 TR |
| DJ-AIGCI | 1.00 | 0.89 | (0.14) | (0.18) |
| Combined | X | 1.00 | (0.13) | (0.16) |
| Lehman | X | X | 1.00 | (0.13) |
| Aggregate | | | | |
| S&P 500 TR | X | X | X | 1.00 |

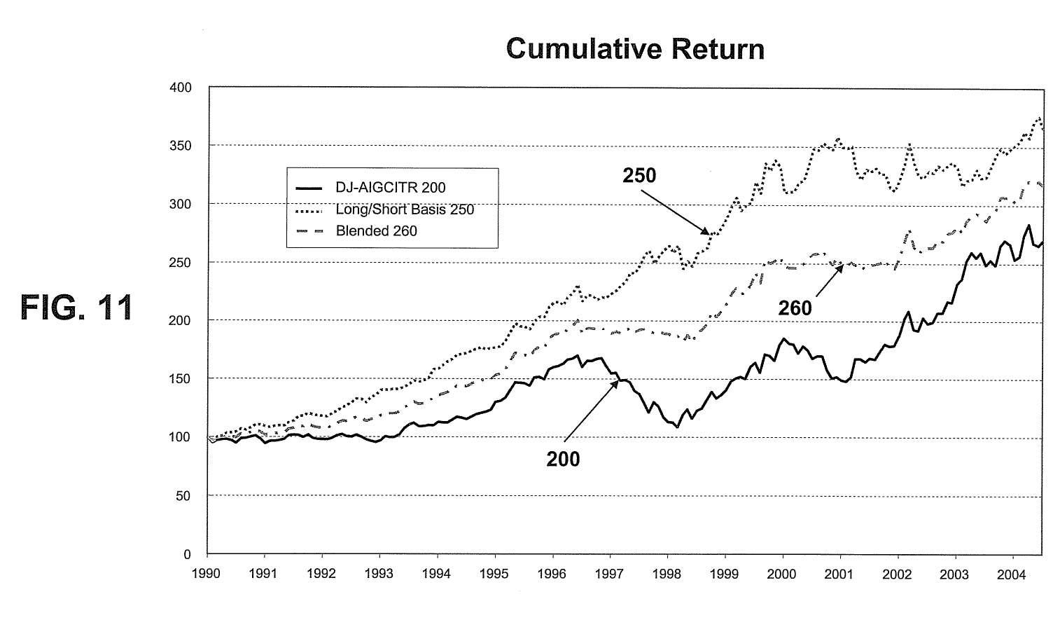

FIG. 11 is a graph comparing the cumulative return for the period from Jan. 2, 1991, to Jun. 30, 2005, for the DJ-AIGCITR index 200 against a long/short basis index 250 generated according to the present invention and against a second blended index 260 generated according to the present invention. The long/short basis index 250 is similar to the basis index 220 described above in connection with FIGS. 3-6 except that the long/short basis index ranks each of the commodities of the DJ-AIGCI according to their relative basis and applies a rule in which it goes long in the nine commodities exhibiting the highest basis, goes short in the nine commodities exhibiting the lowest basis, and takes no position in the remaining commodities.

In this embodiment, the blended index 260 includes a first portion having as its index the long/short basis index 250 and a second portion having as its index the DJ-AIGCITR index 200. The first and second portions of the blended index 260 both comprise fifty percent of the total index 260. In other embodiments, the first and second parts can be weighted differently such that the first and second parts comprise different percentages of the total blended index. The blended index 260 is rebalanced monthly. In other embodiments, the blended index can be rebalanced using a different time period, such as bi-weekly, quarterly, semi-annually, etc. The blended index can have weights, a roll schedule and other aspects that match a standard DJ-AIGCITR^{SM} swap. All data for the blended index 260 represents an historical estimation using available data.

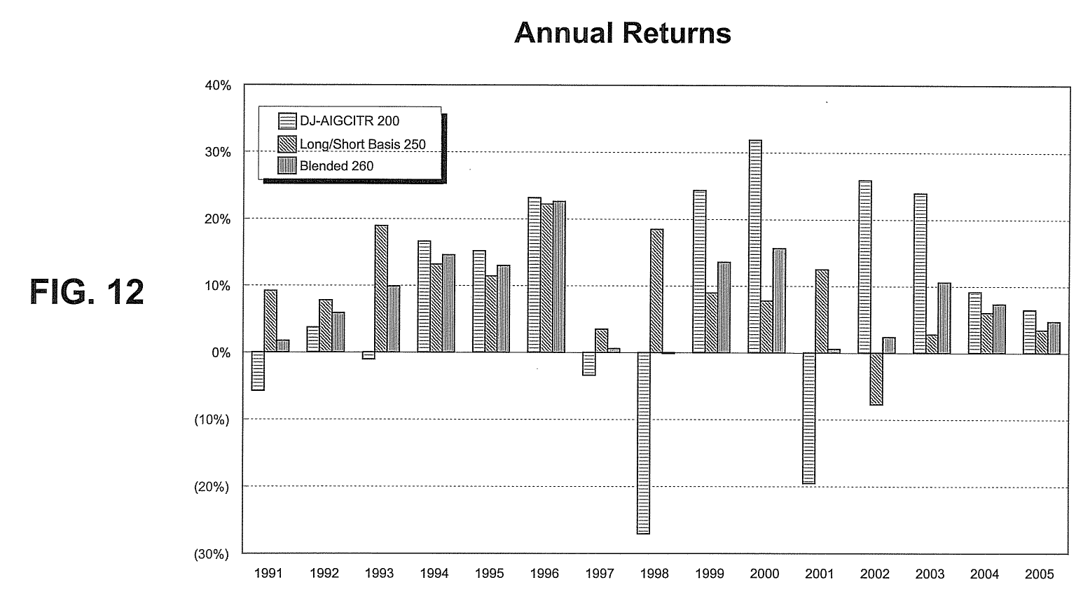

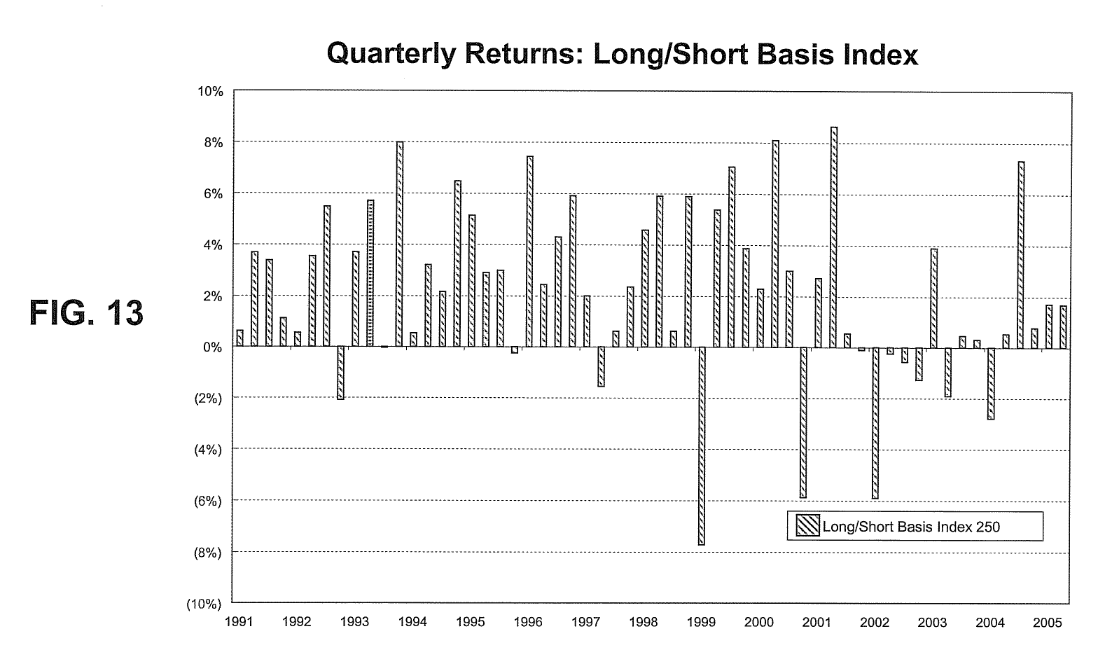

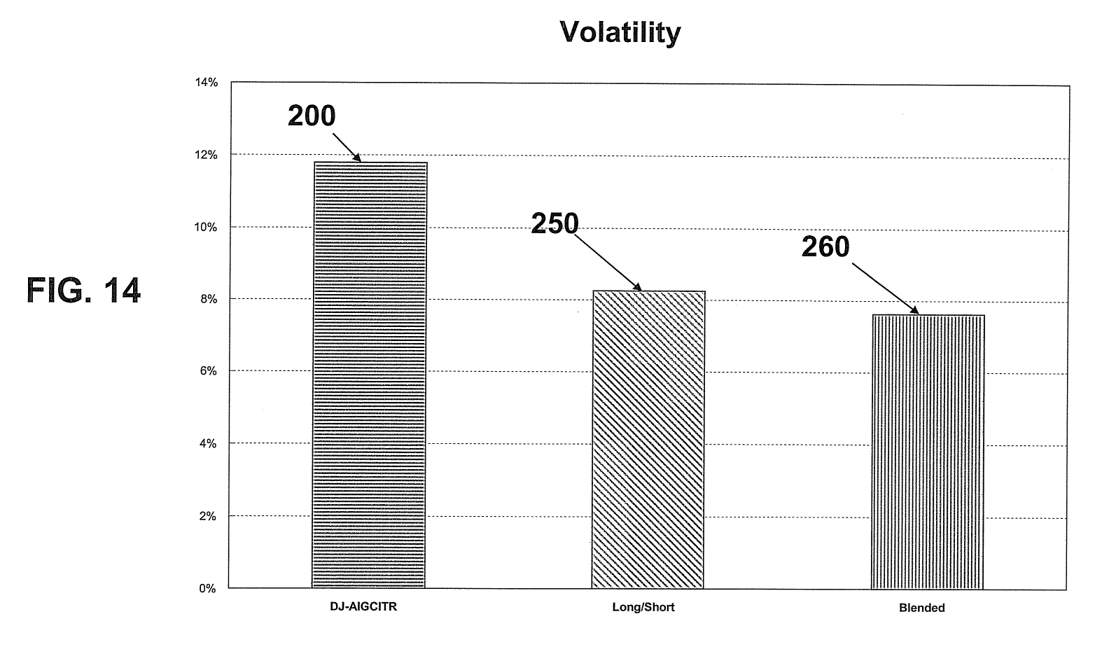

FIG. 12 is a chart of the annual returns (gross of fees) from Jan. 2, 1991, to Jun. 30, 2005 for the DJ-AIGCITR index 200, the long/short basis index 250, and the blended index 260. FIG. 13 is a chart of the quarterly returns (gross of fees) for the long/short basis index 250 between Jan. 2, 1991, to Jun. 30, 2005. FIG. 14 is a chart of the annualized volatility of monthly returns for the DJ-AIGCITR index 200, the long/short basis index 250, and the blended index 260 for the period from Jan. 2, 1991, to Jun. 30, 2005. The long/short basis index 250 and the blended index 260 were less volatile than the DJ-AIGCITR index 200.

The correlation of monthly returns for the ten year period ending Jun. 30, 2005 of the long/short basis index 250 and the DJ-AIGCITR index 200 is 0.106. Table 5 sets forth the corresponding annualized returns (gross of fees), volatilities, and Sharpe ratios for the DJ-AIGCITR index 200, the long/short basis index 250, and the blended index 260 for the one, three, five, and ten year periods ending Jun. 30, 2005, and for the period between Jan. 2, 1991, and Jun. 30, 2005.

TABLE 5
annualized returns, volatilities, and Sharpe ratios for the DJ-AIGCITR index 200,
the long/short basis index 250, and the blended index 260

| Index | Parameter | 1 Year | 3 Year | 5 Year | 10 Year | January 1991 |
|---|---|---|---|---|---|---|
| DJ-AIGCITR | Ann. Return | 8.56% | 17.16% | 10.48% | 8.90% | 7.09% |
| Long/short | Ann. Return | 12.16% | 3.43% | 2.60% | 7.79% | 9.31% |
| basis | | | | | | |
| Blended | Ann. Return | 10.86% | 10.42% | 6.85% | 8.77% | 8.44% |
| DJ-AIGCITR | Volatility | 13.77% | 13.09% | 13.94% | 13.38% | 11.80% |
| Long/short | Volatility | 7.17% | 8.39% | 9.55% | 9.29% | 8.26% |
| basis | | | | | | |
| Blended | Volatility | 6.90% | 8.40% | 8.63% | 8.42% | 7.62% |
| DJ-AIGCITR | Sharpe Ratio | 0.48 | 1.20 | 0.58 | 0.38 | 0.27 |
| Long/short | Sharpe Ratio | 1.42 | 0.24 | 0.02 | 0.44 | 0.66 |
| basis | | | | | | |
| Blended | Sharpe Ratio | 1.29 | 1.07 | 0.51 | 0.60 | 0.60 |

Additional results are summarized below in Tables 6 and 7. Table 6 shows results for the long-only indices. Results are shown for two subperiods. The first subperiod is 1959-2005, over which we examine returns using the Gorton-Rouwenhorst equally-weighted (GR EW) index (see Rouwenhorst, K. Geert and Gorton, Gary B., “Facts and Fantasies about Commodity Futures” (Feb. 28, 2005), Yale ICF Worling Paper No. 04-20, available at SSRN: http://ssrn.com/abstract=560042). The GR EW index is a benchmark for comparison purposes in the first sub-period. The second subperiod is 1991-2005, the period over which there are data on the DJAIGCI, so that index, as well as the GR EW index, is included as benchmarks.

The notation for Table 6 is as follows:
“GR EW” means the Gorton and Rouwenhorst (GR) equally-weighted index.
“High Basis EW Near” is an index of those commodities in the GR index with a higher than median basis, measured at the end of the previous month. The index is equally weighted (EW) and uses the nearest to maturing contract (“Near”).
“High Basis EW Distant” is the same as above, but sorts every two months and uses the nearest contract with at least two months to maturity.
“High 12m ER EW Near” means that those commodities whose previous 12-month return was above median are selected to enter an index with equal weights, using the nearest-to-maturity contract.
“High 12m ER EW Distant” is the same as above, but sorts every two months and uses the nearest contract with at least two months to maturity.
“High Basis DJAIG Weights” means the commodities have been selected based on their basis, but the index then uses DJAIGCI weights. More about this is explained below.

“High 12m ER DJAIG Weights” means that those commodities whose previous 12-month return was above median are selected to enter the index, which then uses DJAIGCI weights.

TABLE 6
Long-Only Strategies: Fully-Collateralized and Over-Collateralized
Excess Returns

| | | | | | | |
|---|---|---|---|---|---|---|
| | | | | % | Skew- | |
| Strategy | Mean | STD | Sharpe | Pos. | ness | Kurtosis |

| | 1959-2005 | | | | | |
|---|---|---|---|---|---|---|
| GR EW | 5.22% | 12.08% | 0.43 | 55% | 0.59 | 4.44 |
| High Basis EW | 9.91% | 13.74% | 0.72 | 56% | 0.61 | 4.46 |
| Near | 4.70% | 6.44% | | | | |
| High Basis EW | 10.01% | 13.44% | 0.75 | 57% | 0.72 | 4.53 |
| Distant | 4.76% | 6.31% | | | | |
| High 12 m EW | 11.99% | 14.74% | 0.81 | 59% | 0.45 | 3.64 |
| Near | 5.66% | 6.91% | | | | |
| High 12 m EW | 12.01% | 15.16% | 0.79 | 58% | 0.43 | 3.40 |
| Distant | 5.66% | 7.11% | | | | |
| | 1991-2005 | | | | | |
| GR EW | 3.38% | 8.16% | 0.41 | 56% | −0.14 | −0.13 |
| DJAIG | 3.64% | 12.07% | 0.30 | 53% | 0.17 | 0.28 |
| High Basis EW | 7.76% | 9.59% | 0.81 | 58% | 0.06 | 0.13 |
| Near | 3.86% | 4.74% | | | | |
| High Basis EW | 8.27% | 9.72% | 0.85 | 59% | −0.02 | 0.20 |
| Distant | 4.11% | 4.80% | | | | |
| High Basis | 7.48% | 13.78% | 0.54 | 59% | −0.06 | 0.83 |
| DJAIG Weights | 4.47% | 7.65% | | | | |
| High 12 m EW | 10.34% | 9.61% | 1.08 | 62% | 0.24 | 0.39 |
| Near | 5.87% | 4.74% | | | | |
| High 12 m EW | 9.75% | 9.96% | 0.98 | 61% | 0.19 | 0.20 |
| Distant | 5.50% | 4.92% | | | | |
| High 12 m | 7.97% | 14.53% | 0.55 | 56% | 0.13 | 0.59 |
| DJAIG Weights | 5.50% | 8.74% | | | | |

TABLE 7
Long-Short Strategies: Excess Returns

| | | | | % | Skew- | |
|---|---|---|---|---|---|---|
| Strategy | Mean | STD | Sharpe | Pos. | ness | Kurtosis |
| | 1959-2005 | | | | | |
| GR EW | 5.22% | 12.08% | 0.43 | 55% | 0.59 | 4.44 |
| L-S Basis EW | 4.17% | 5.61% | 0.74 | 60% | 0.06 | 1.43 |
| Near | | | | | | |
| L-S Basis EW | 4.31% | 5.38% | 0.80 | 60% | 0.05 | 1.41 |
| Distant | | | | | | |
| L-S 12 m EW | 5.92% | 6.29% | 0.94 | 61% | 0.27 | 1.65 |
| Near | | | | | | |
| L-S 12 m EW | 5.91% | 6.42% | 0.92 | 62% | 0.28 | 1.80 |
| Distant | | | | | | |
| | 1991-2005 | | | | | |
| GR EW | 3.38% | 8.16% | 0.41 | 56% | −0.14 | −0.13 |
| DJAIG | 3.64% | 12.07% | 0.30 | 53% | 0.17 | 0.28 |
| L-S Basis EW | 3.64% | 4.73% | 0.77 | 60% | 0.02 | −0.01 |
| Near | | | | | | |
| L-S Basis EW | 4.52% | 4.69% | 0.96 | 60% | 0.29 | 0.61 |
| Distant | | | | | | |
| L-S Basis DJAIG | 5.32% | 8.18% | 0.65 | 61% | −0.63 | 1.54 |
| Weights | | | | | | |
| L-S 12 m EW | 6.16% | 5.46% | 1.13 | 65% | −0.53 | 1.75 |
| Near | | | | | | |
| L-S 12 m EW | 5.88% | 5.56% | 1.06 | 64% | −0.47 | 1.77 |
| Distant | | | | | | |
| L-S 12 m DJAIG | 5.58% | 9.15% | 0.61 | 57% | −0.31 | 1.96 |
| Weights | | | | | | |

Why are there so many choices concerning the weights and the futures contract used for the indices? The proposed trading strategies are dynamic, involve more trading, and so introduce more trading costs. The various choices concerning weights and futures can allow one to reduce the trading costs associated with periodically re-balancing the index.

Trading costs resulting from re-balancing can be reduced by timing the re-balance to coincide with a roll period such that the portfolio rebalances during the usual roll period. In other words, in many cases when the index has to trade, it would trade anyway in order to roll. Therefore, the trading costs are not much higher.

By increasing the period between successive re-balances, the trading costs can be further reduced. For example, in one embodiment of the method of the present invention where an equally-weighted index is rebalanced every month, there are clearly higher trading costs compared to the DJAIGCI or the GR EW index. In another embodiment of the invention where an equally-weighted index is rebalanced every two months, trading costs are reduced. The reason is as follows. Equally-weighting and rebalancing every month means that about 20% of the commodity futures would trade every month (on average). These trading costs can be reduced by sorting on the signals and then trading only every two months and entering into futures contracts that last at least two months. Again, rebalancing based on the signals and rolling coincides. The trading costs comparisons are analyzed below.

In terms of results, we concentrate on the Sharpe Ratio and the percentage of positive monthly returns.

Table 6 has the results for the long-only indices on both fully-collateralized and overcollateralized bases. Overcollateralized indices invest in T-bills, the weights which their benchmark (DJAIGCI or GR EW) allocates to commodity futures which did not enter the long-only index. The overcollateralized index represents the performance of the combination position in the benchmark and in the Long-Short index. Looking at Table 6, the following can be noted:
During the period 1959-2005 the Commodity Value Indices (High Basis EW Near and High Basis EW Distant) and the Commodity Momentum Indices (High 12m Near and High 12m EW Distant), the two long-only basis indices, have Sharpe Ratios that significantly exceed the benchmark of the EW index. The percentage positive is slightly higher.
During the period 1991-2005 we also have the additional indices that use the DJAIGCI weights. These indices slightly underperform their equal-weighted counterparts, but outperform the plain vanilla DJAIGCI. The overcollateralized indices have about the same return as their benchmark, meaning that the average long term risk premium of low basis and low momentum commodity futures is close to zero, while they dramatically outperform the benchmark on the fully collateralized basis.

Table 7 provides the results for the Relative Value Commodity Index and the Relative Value Momentum Index, the two long-short (L-S) indices. We note the following:
During the period 1959-2005 the Relative Value Commodity Index and the Relative Value Momentum Index have significantly higher Sharpe Ratios and also a higher percentage of positive monthly returns.
During the period 1991-2005 we have the additional indices based on DJAIGCI weights. These indices outperform the DJAIGCI. The equally weighted indices are significantly better than their EW benchmark.

The findings that the Sharpe Ratios are higher for these new indices, sometimes a lot higher, suggests that these strategies are not widely known. Since the higher excess return is compensation for risk, the Sharpe Ratios should not be higher (though this is subject to the caveat that futures returns are not normally distributed so the Sharpe Ratio is not a complete picture of the risk).

Overall, the results can be viewed as confirmation of the economic rationale.

Comparison with CTAs: To compare with CTA performance, we use the two indices mostly widely cited as CTA benchmarks: (1) the Managed Futures CTA return index from CFSB Tremont (“the Tremont Managed Futures Index”), see http://www.hedgeindex.com/, and (2) the Barclays CTA Index. See htti)://www.barclaygrp.com/.

The Tremont Managed Futures Index begins in 1994 and includes funds from all over the world. According to CSFB Tremont's web site: “The Index in all cases represents at least 85% of the AUM [assets under management] in each respective category of the Index Universe.” The Tremont Managed Futures Index is described as follows by Tremont: “This strategy invests in listed financial and commodity futures markets and currency markets around the world. The managers are usually referred to as Commodity Trading Advisors, or CTAs. Trading disciplines are generally systematic or discretionary. Systematic traders tend to use price and market specific information (often technical) to make trading decisions, while discretionary managers use a judgmental approach.” To be included in the index Tremont requires: (1) a minimum of US $50 million assets under management (“AUM”); (2) a minimum one-year track record; and (3) current audited financial statements. See https://www.hedgeindex.com/secure/analytics.cfm?sID=571.

The Barclays CTA Index is available starting in 1980. According to Barclays: “The Barclay CTA Index is a leading industry benchmark of representative performance of commodity trading advisors. There are currently 396 programs included in the calculation of the Barclay CTA Index for the year 2005, which is unweighted and rebalanced at the beginning of each year. To qualify for inclusion in the CTA Index, an advisor must have four years of prior performance history. Additional programs introduced by qualified advisors are not added to the Index until after their second year. These restrictions, which offset the high turnover rates of trading advisors as well as their artificially high short-term performance records, ensure the accuracy and reliability of the Barclay CTA Index.” See htt-p://www.barclaygry.com/indices/cta/sub/cta.html.

There are reasons to believe that our rules-based indices are at a disadvantage when compared to the two CTA indices. First, the CTAs included in the two indices can use financial futures, in addition to commodity futures. Second, the CTAs can use discretion, as they are not bound by any trading rules. They can use their trading acumen. Third, CTAs can trade at any time, while our passive strategies trade only at the closing prices during the roll period. Finally, the indices likely only include successful CTAs. Unsuccessful CTAs may never enter either index to start with.

According to Tremont: “Most indices are affected by some form of survivorship bias. In order to minimize this effect, the Index does not remove finds in the process of liquidation, and therefore captures all of the potential negative performance before a fund ceases to operate.” But, this does not address the adverse selection concerning which CTAs are in the index to start with.

Table 8 shows the results of the comparison. There are two sample periods because the two CTA indices span different periods and we want to compare to the benchmark of the DJAIGCI. The CSFB Tremont data is confined to the period 1994-2005. The Barclays CTA Index is available during 1991-2005, the period corresponding to when we have data for the DJAIGCI.

TABLE 8
Comparison with CTAs: Excess Returns

| | | | | % | Skew- | |
|---|---|---|---|---|---|---|
| Strategy | Mean | STD | Sharpe | Pos. | ness | Kurtosis |
| | 1994-2005 | | | | | |
| GR EW | 4.56% | 8.45% | 0.54 | 59% | −0.18 | −0.14 |
| DJAIG | 6.03% | 12.94% | 0.47 | 55% | 0.11 | −0.08 |
| L-S Basis Near | 3.68% | 4.83% | 0.76 | 58% | 0.13 | −0.07 |
| L-S Basis Distant | 4.64% | 4.79% | 0.97 | 59% | 0.48 | 0.54 |
| L-S Basis DJAIG | 4.78% | 8.71% | 0.55 | 61% | −0.60 | 1.31 |
| Weights | | | | | | |
| L-S 12 m Near | 6.56% | 5.73% | 1.14 | 64% | −0.57 | 1.76 |
| L-S 12 m Distant | 6.29% | 5.87% | 1.07 | 64% | −0.55 | 1.71 |
| L-S 12 m DJAIG | 5.04% | 9.86% | 0.51 | 55% | −0.25 | 1.57 |
| Weights | | | | | | |
| Tremont | 2.58% | 12.24% | 0.21 | 49% | 0.38 | 0.07 |
| Managed | | | | | | |
| Futures | | | | | | |
| | 1991-2005 | | | | | |
| GR EW | 3.38% | 8.16% | 0.41 | 56% | −0.14 | −0.13 |
| DJAIG | 3.64% | 12.07% | 0.30 | 53% | 0.17 | 0.28 |
| L-S Basis Near | 3.64% | 4.73% | 0.77 | 60% | 0.02 | −0.01 |
| L-S Basis Distant | 4.52% | 4.69% | 0.96 | 60% | 0.29 | 0.61 |
| L-S Basis DJAIG | 5.32% | 8.18% | 0.65 | 61% | −0.63 | 1.54 |
| Weights | | | | | | |
| L-S 12 m Near | 6.16% | 5.46% | 1.13 | 65% | −0.53 | 1.75 |
| L-S 12 m Distant | 5.88% | 5.56% | 1.06 | 64% | −0.47 | 1.77 |
| L-S 12 m DJAIG | 5.58% | 9.15% | 0.61 | 57% | −0.31 | 1.96 |
| Weights | | | | | | |
| Barclays CTA | 1.92% | 8.87% | 0.22 | 48% | 0.47 | 0.44 |
| Index | | | | | | |

Table 8 shows the following:
Both CTA performance indices underperform any of the other indices, based on the Sharpe Ratio. The plain vanilla EW index or the DJAIGCI have Sharpe Ratios twice those of the CTAs.
The CTAs' Sharpe Ratio is less than one fifth that of the equally-weighted momentum indices or basis indices, and is about one third of the Sharpe Ratio of the strategies using the DJAIGCI weights.
Significantly, less than half of the month returns are positive for the CTA indices.

Relative to rules-based strategies, CTAs appear to be inefficient. However, their performance indices are after fees. If we take account of the costs of trading, do the results still stand up?

Trading Costs: Trading costs are due to rolling futures and due to portfolio rebalancing based on the basis or momentum signals. Rebalancing based on the signals potentially requires additional trading, and hence incurs additional costs. How big are these costs? Do they make the new indices prohibitively expensive?

As mentioned above, some of the indices have been constructed to reduce trading costs. We provide two different estimates of trading costs. In the first approach we split the costs based on roll and rebalancing notional. To arrive at actual trading costs the notional has to be multiplied by the average cost. In the second approach we split the costs by brokerage and slippage by incorporating commodity specific commissions and bid-ask spreads. The two approaches are complementary. The first approach distinguishes between rolling and rebalancing, but does not distinguish between commodity specific brokerage and slippage. The second approach is commodity specific, but does not distinguish between roll and rebalancing.

For long only strategies the trading costs are estimated on the over-collateralized versions.

In the second approach, trading costs are a sum of brokerage costs and “slippage.” Slippage (s) is equal to half of the bid-ask spread. Bid-ask spread is assumed to be fixed in $, not as % of price. Brokerage and execution costs (bce) are fixed in $/contract.

Trading Cost Calculations. Details of methods to calculate trading costs include the following. Let w1 be the weight of the outgoing (front month) contract and w2 be the weight of the incoming (back month) contract.
Rebalancing Notional=|w1−w2|.
If there is no roll (front month is the same as back month), then Roll Notional=0, else Roll Notional=|w1|+|w2|−Rebalancing Notional.
   For example, if we switch from 16% long to 15% long we have w1=16% and w2=15%:
a) No roll: Rebalancing Notional=1%, Roll Notional=0
b) Roll: Rebalancing Notional=1%, Roll Notional=30%
   If we switch from 16% short to 15% long we have w1=−16% and w2=15%
c) No roll: Rebalancing Notional=31%, Roll Notional=0
d) Roll: Rebalancing Notional=31%, Roll Notional=0−entire notional amount rolls and rebalances at the same time and is assigned to rebalancing, rather than to rolling in this case.

Trading Costs are a sum of brokerage costs and “slippage.” Slippage (s) is equal to half of the bid-ask spread. Bid-ask spread is assumed to be fixed in $, not as % of price. Brokerage and execution costs (bce) are fixed in $/contract. Let the futures price be denoted p and let w be the weight, as above. Then:
Number of contracts per $1 of notional=N=w*number of units per contract/p;
Brokerage costs=bce*N=(w/p)*bce/(contract size);
Slippage costs=(w/p)*s.

Table 9 shows the estimated trading costs. Numbers in the table have the following meaning. The first three columns, Roll Notional, Rebalancing Notional, and Total Notional, are multiples of one dollar of a futures position. For example, a Roll Notional of 16.31 means that for every dollar of notional, 16.31 dollars are rolled during the year to support that position. The last three columns give the brokerage costs, slippage costs and total costs as basis points per year.

TABLE 9
Trading Costs over the Period 1991-2005

| | | | | Brokerage | Slippage | Total |
|---|---|---|---|---|---|---|
| | Roll | Rebalancing | Total | Costs | Costs | Costs |
| Strategy | Notional | Notional | Notional | (bp) | (bp) | (bp) |
| | Long-Only Strategies | | | | | |
| GR EW | 16.13 | 0.68 | 16.81 | 136 | 118 | 254 |
| DJAIG | 10.90 | 0.37 | 11.27 | 20 | 70 | 90 |
| High Basis EW | 6.54 | 2.81 | 9.35 | 58 | 70 | 127 |
| Near | | | | | | |
| High Basis EW | 3.20 | 1.51 | 4.71 | 29 | 34 | 63 |
| Distant | | | | | | |
| High Basis | 4.66 | 2.67 | 7.33 | 12 | 41 | 53 |
| DJAIG Weights | | | | | | |
| High 12 m ER EW | 7.06 | 1.75 | 8.81 | 15 | 59 | 74 |
| Near | | | | | | |
| High 12 m ER EW | 3.47 | 0.99 | 4.46 | 8 | 30 | 38 |
| Distant | | | | | | |
| High 12 m ER | 5.13 | 1.78 | 6.91 | 11 | 39 | 50 |
| DJAIG Weights | | | | | | |
| | Long-Short Strategies | | | | | |
| GR EW | 16.13 | 0.68 | 16.81 | 136 | 118 | 254 |
| DJAIG | 10.90 | 0.37 | 11.27 | 20 | 70 | 90 |
| High Basis EW | 12.70 | 5.60 | 18.31 | 148 | 142 | 290 |
| Near | | | | | | |
| High Basis EW | 6.18 | 3.01 | 9.19 | 73 | 71 | 144 |
| Distant | | | | | | |
| High Basis | 8.38 | 5.61 | 13.99 | 25 | 86 | 111 |
| DJAIG Weights | | | | | | |
| High 12 m ER EW | 13.94 | 3.48 | 17.42 | 96 | 125 | 221 |
| Near | | | | | | |
| High 12 m ER EW | 6.82 | 1.94 | 8.76 | 48 | 64 | 111 |
| Distant | | | | | | |
| High 12 m ER | 9.26 | 3.80 | 13.06 | 23 | 82 | 105 |
| DJAIG Weights | | | | | | |

The table shows that the equally-weighted index is quite expensive as it rolls more, using all available contracts. The equally-weighted index does not involve much rebalancing, even though each month it must rebalance back to equal weights. The “High Basis EW Near” index only goes long one half of the commodities in the equally-weighted index, so the cost is reduced to less than half.

We observe the following about the costs of the new indices:
With respect to the long-only indices, except for the High Basis EW Near index the costs of the new indices are less than that of the DJAIGCI. The main reason for this is that these are long-only indices, so fewer commodities are involved.
With respect to the long-only indices, those using the DJAIGCI weights are lower than the others, but not by a significant amount. The reason is the higher energy weights in DJAIGCI and energy commodities have lower costs.
The long-short indices have higher costs, because they involve trading more commodities. Again, those with DJAIGCI weights have the lowest costs, but not by much.

The trading costs reduce the average return of each index. But, the trading costs are not enough to improve the relative performance of the average CTA. For CTAs the problem is that their returns are also more volatile, so the Sharpe Ratio for CTAs remains woefully low by comparison.

In yet another embodiment of the invention, a method for generating a futures index can select emerging commodity futures based on the most liquid commodity contracts from other countries, such as Japan, China, India, Thailand, Argentina, Malaysia, Brazil, South Africa, Canada, Poland, Hungary and so on. Information on emerging commodity exchanges can be found at: http://r0.unctad.org/infocomm/exchanges/ex overview.htm. Some of these countries have only recently started their futures exchanges, or dormant exchanges seem to have come to life.

The idea of this index is that the risk premium may be higher in newly emerging contracts. As a result, it may be that the rules for this index might be more flexible, allowing for the components of the index to change based on liquidity and performance, including a managing committee having more discretion to alter the index. The index could be quasi-rules-based rather than with hard and fast rules. The index would also provide additional diversification benefit by exposure to different commodity futures that are not traded in the US or Europe as well as different currencies. The index can also include an averaging-based entry and exit strategy, so investors can get out but at an average price over, say, three days.

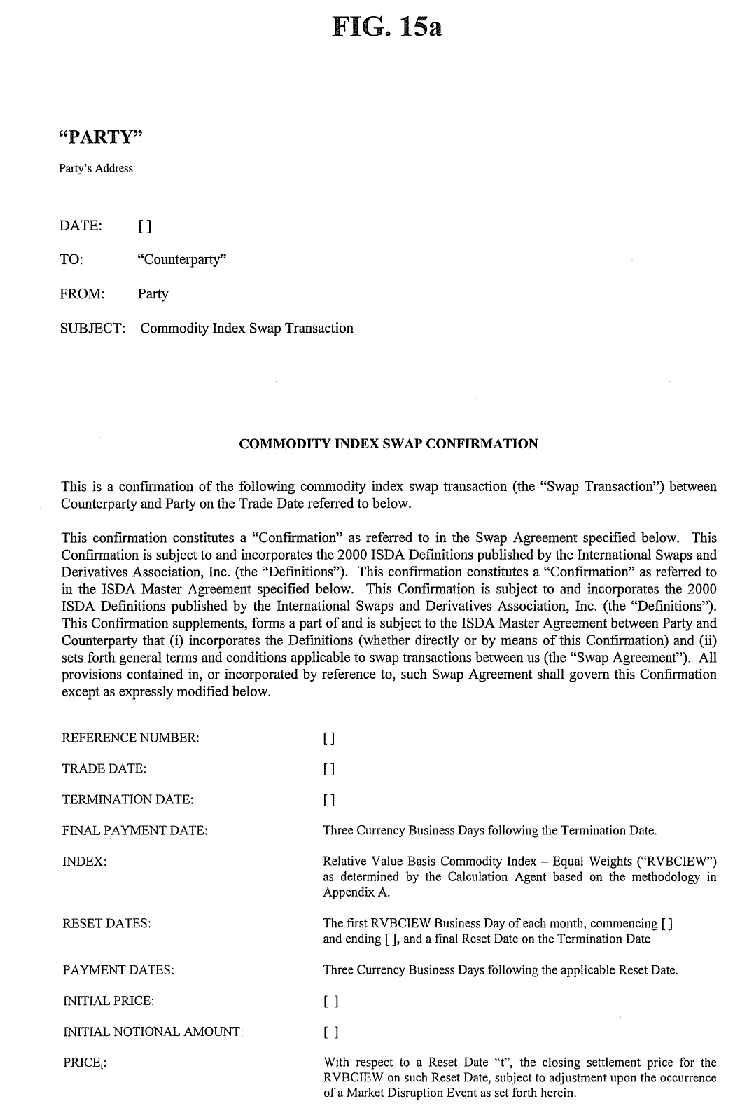

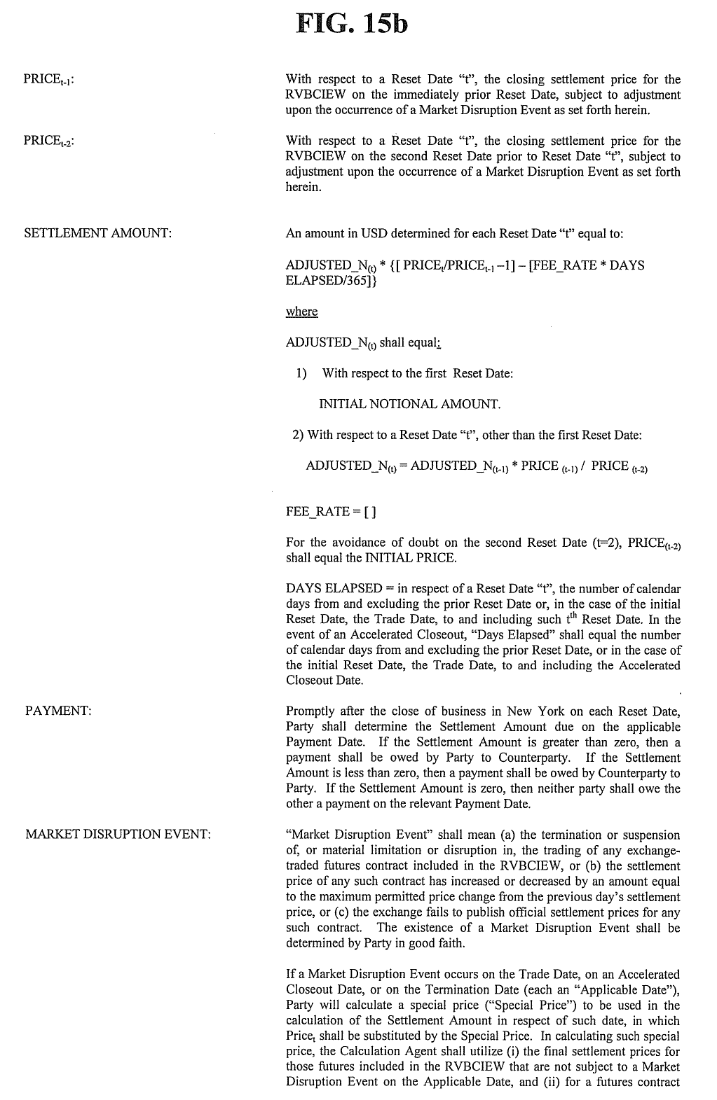

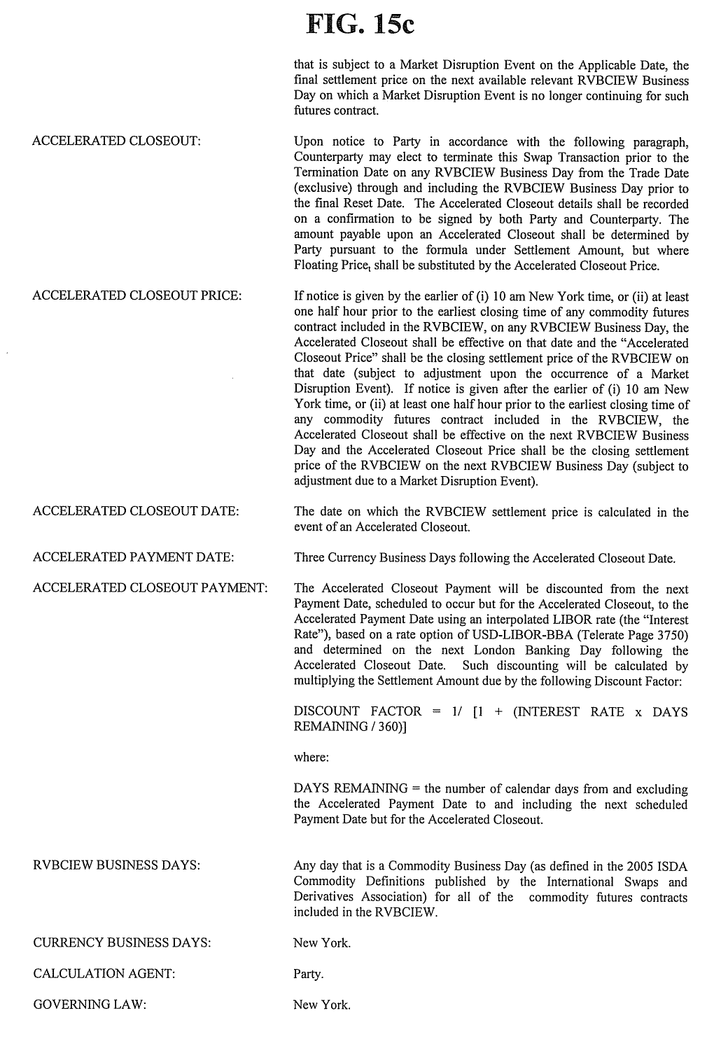

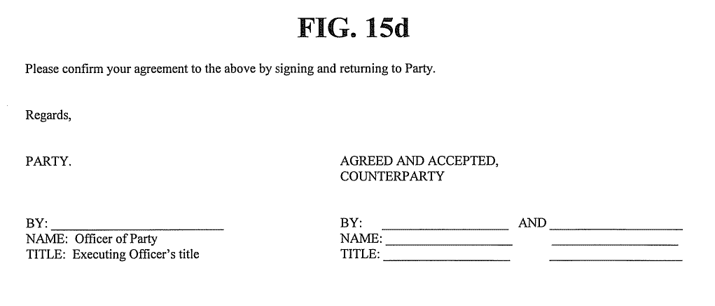

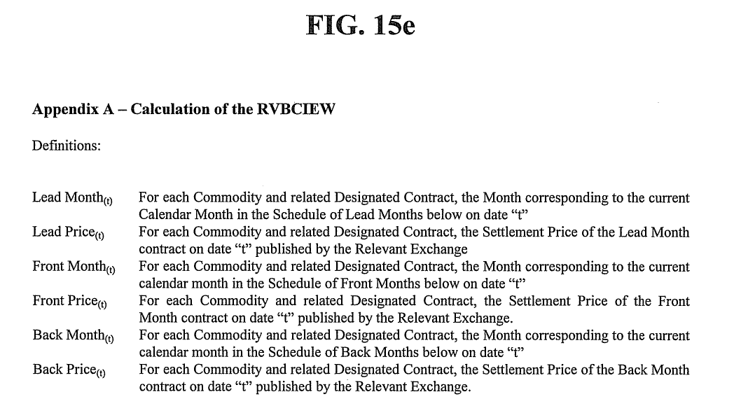

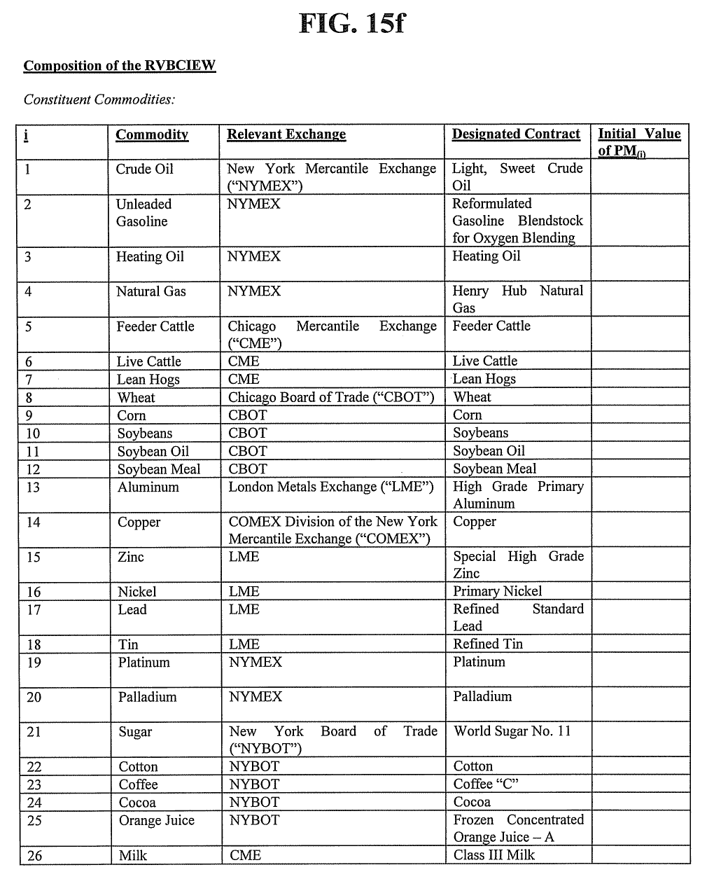

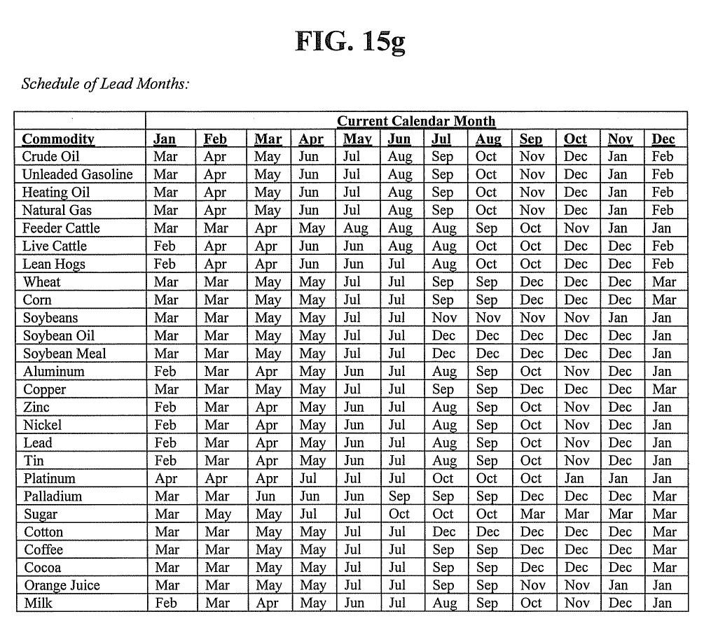

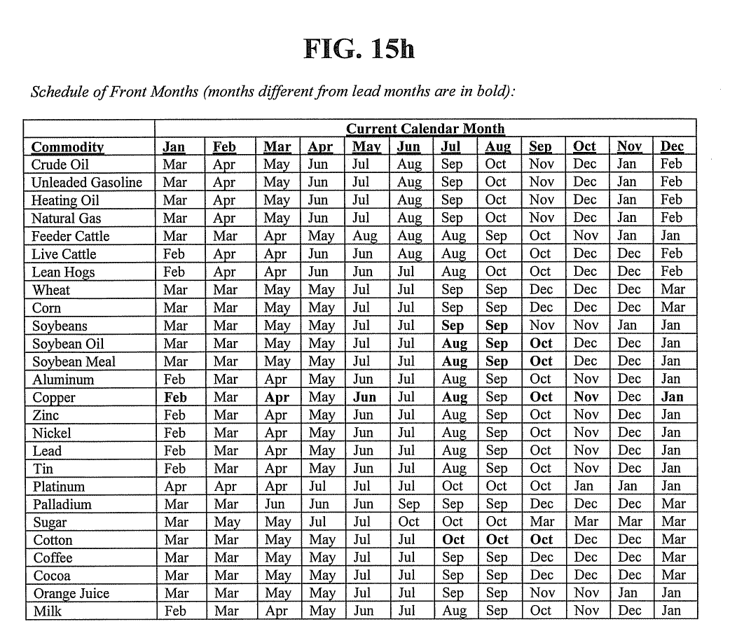

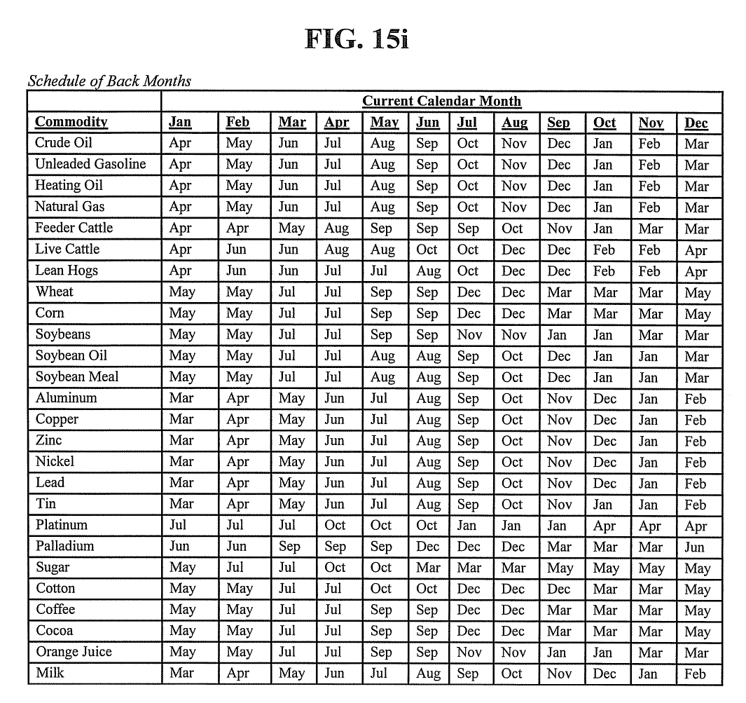

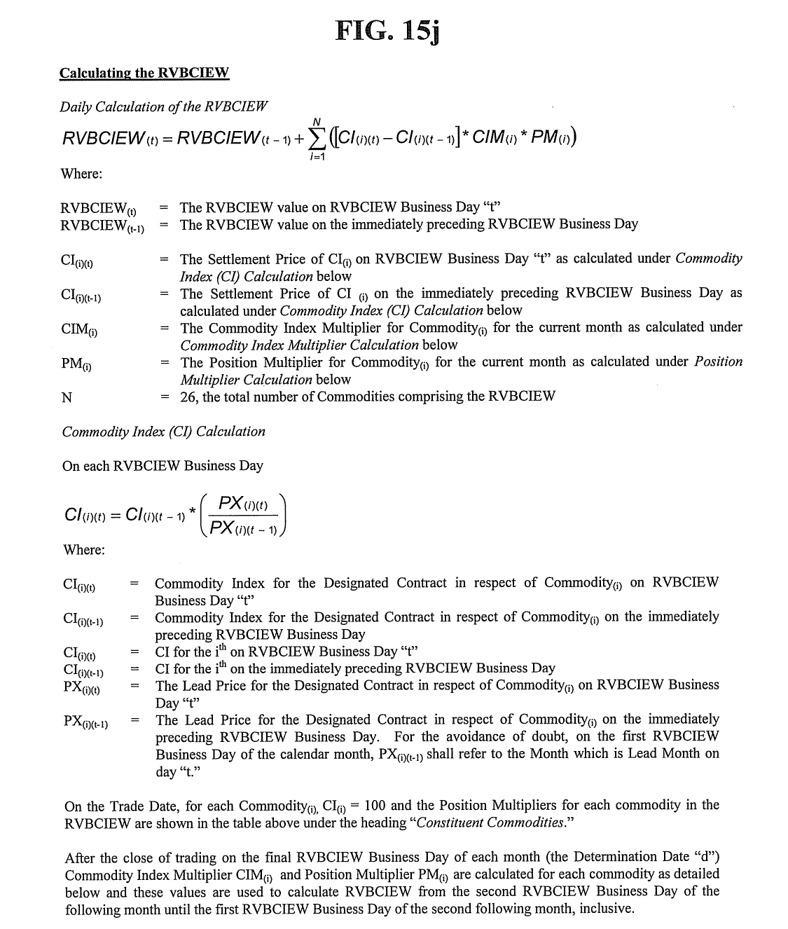

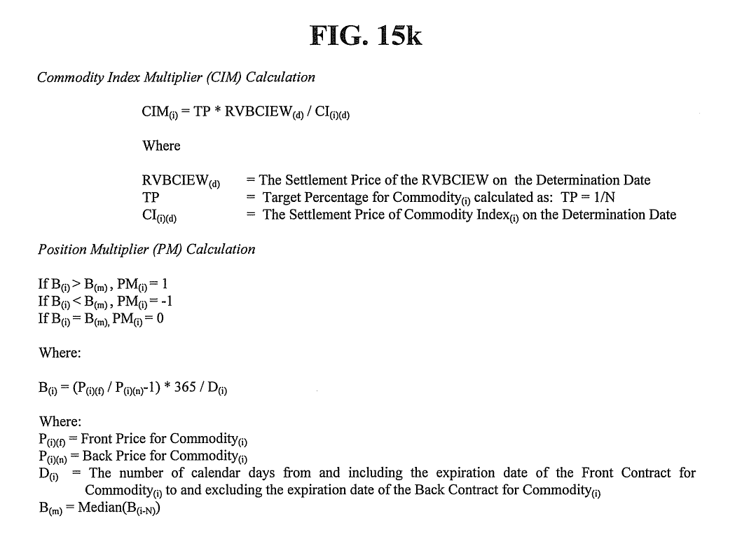

An index generated by the method of the present invention can be delivered to a client in swap form, on either a total return or excess return basis, for example. Specimens of exemplary swap agreements for an index generated using the method of the present invention are depicted in FIGS. 15 and 16.

FIG. 15 comprises a specimen of a swap transaction confirmation relating to a long-short index generated using a method according to the present invention wherein the basis of each commodity in the set of identified commodities is measured to rank the commodities. The swap transaction in FIG. 15 is a commodity index swap transaction between “Party” and “Counterparty.” The presence of brackets “[ ]” in the specimen indicates data, such as that can be filled in unilaterally by the Party or by agreement of the Party and the Counterparty. Information in the specimen of FIG. 15 that has been left to be decided by the parties and/or completed by the Party are a reference number for the swap transaction, the trade date, the termination date, the reset dates, the initial price, the initial notional amount, and the fee rate. In addition, the initial value of the Position Multiplier for each commodity can be computed at the time of execution of the swap transaction.

The Trade Date is the first date on which a trade occurs, the starting date of the swap transaction. The Termination Date is the date when the swap transaction ends. The Final Payment Date can be three currency business days following the Termination Date. The Index can be any suitable index generated according to the method of the present invention. In this instance, the method uses the relative basis of each commodity as the signal being ranked and is computed in accordance with the information set forth in Appendix A of the specimen of FIG. 15. The Reset Date is the date on which the index is re-balanced and can be once a month as stated in the specimen of FIG. 15. In other embodiments, the Reset Date can be different. The Payment Date can be three currency business days following the corresponding Reset Date. The Initial Price and the Initial Notional Amount can be determined as of the Trade Date or at some other predetermined time.

At the close of business in New York on each Reset Date, the Party can determine the Settlement Amount due on the applicable Payment Date according to the formula set forth in the swap transaction specimen of FIG. 15. If the Settlement Amount is greater than zero, then a payment in the amount of the Settlement Amount is owed by the Party to the Counterparty on the applicable Payment Date. If the Settlement Amount is less than zero, then the Counterparty owes the Party a payment in the amount of the Settlement Amount on the applicable Payment Date. If the Settlement Amount is zero, then neither party shall owe the other a payment on the relevant Payment Date.

The terms and the operation of the swap transaction can be understood by one of skill in the art after reviewing the specimen of FIG. 15. It will be appreciated that other terms can be used in other embodiments of a commodity index swap transaction according to the present invention.

FIG. 16 depicts another specimen of a swap transaction confirmation relating to a long-short index generated using a method according to the present invention wherein the momentum of each commodity in the set of identified commodities is measured to rank the commodities. The swap transaction specimen of FIG. 16 is similar in other respects to the swap transaction of FIG. 15.

All references, including web pages, publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

While this invention has been described with an emphasis upon exemplary embodiments, variations of the exemplary embodiments can be used, and it is intended that the invention can be practiced otherwise than as specifically described herein. Accordingly, this invention includes all modifications and equivalents encompassed within the spirit and scope of the invention as defined by the claims. Moreover, any combination of the above-described elements in all possible variations thereof is encompassed by the invention unless otherwise indicated herein or otherwise clearly contradicted by context.

What is claimed is:

1. A method for creating a commodity futures index comprising the steps of:
identifying a set of at least two traded commodity futures;
selecting a parameter to measure a risk premium signal of each commodity future of the set;
calculating the signal for each commodity future of the set;
ranking the set of commodity futures relative to each other according to the value of the signal for each commodity future;
applying a predetermined rule to each commodity future of the set to select, depending on its ranking, in which commodity futures of the set of commodity futures a position is taken;
taking a position in each selected commodity future of the set.

2. The method according to claim 1, wherein the set of commodity futures comprises commodity futures traded on at least one existing organized commodity futures exchange.

3. The method according to claim 1, wherein the parameter is a “direct” value.

4. The method according to claim 3, wherein the parameter comprises a “spot” price, measured by the nearest to maturity futures contract.

5. The method according to claim 1, wherein the parameter is a calculated value

6. The method according to claim 5, wherein the parameter comprises a basis percentage.

7. The method according to claim 1, wherein the measured parameter comprises a relative basis calculation, and the ranked list assigns the commodity futures with the highest basis in the set with the top ranking and the commodity with the lowest basis in the set with the lowest ranking.

8. The method according to claim 1, wherein the measured parameter comprises a relative momentum calculation, and the ranked list assigns the commodity with the highest momentum in the set with the top ranking and the commodity with the lowest momentum in the set with the lowest ranking.

9. The method according to claim 1, wherein the predetermined rule comprises the acquisition of a long position in the commodity of the set having the highest ranking.

10. The method according to claim 9, wherein the predetermined rule comprises the acquisition of a short position in the commodity of the set having the lowest ranking.

11. The method according to claim 1, wherein the predetermined rule comprises the acquisition of a long position in the commodity of the set having the lowest ranking.

12. The method according to claim 1, wherein the predetermined rule comprises the acquisition of no position in at least one commodity of the set.

13. The method according to claim 1, wherein the set of commodities comprises nineteen commodities traded in at least one pre-existing commodity index, and the predetermined rule comprises the acquisition of a long position in the nine commodities of the set having the nine-highest rankings.

14. The method according to claim 13, wherein the set of commodities comprises nineteen commodities traded in at least one pre-existing commodity index, and the predetermined rule comprises the acquisition of a short position in the nine commodities of the set having the nine-lowest rankings.

15. The method according to claim 1, wherein the predetermined rule comprises a weighting factor for at least one commodity future such that when the weighted commodity future has a ranking that requires taking either a long or a short position in the weighted commodity future according to the predetermined rule, the amount of the position in the weighted commodity future is different than the amount of the position in at least one other commodity future of the set which has a ranking that requires taking either a long or short position according to the predetermined rule.

16. The method according to claim 1, further comprising:
allowing a predetermined amount of time to pass;
re-balancing the set of at least two traded commodity futures by:
re-calculating the parameter for each commodity future of the set once the predetermined amount of time has passed;
re-ranking the set of commodity futures relative to each other according to the re-calculated value of the parameter for each commodity future;
re-applying a predetermined rule to acquire a second position for each commodity future in the set depending on its re-ranking.

17. The method according to claim 1, further comprising:
forming a swap, option or derivative transaction including commodity futures for which a position was taken according to the application of the predetermined rule.

18. The method according to claim 17, wherein the swap transaction further includes a re-balancing provision wherein once a predetermined amount of time has elapsed, the parameter for each commodity future of the set is re-calculated, the set of commodity futures is re-ranked based on the re-calculated parameter, and the predetermined rule is re-applied to acquire a second position for each commodity future in the set depending on its re-ranking.

19. A method for creating a commodity futures index comprising the steps of:
identifying a set of at least two traded commodity futures;
determining a relative basis for each commodity future;
ranking the set of commodity futures relative to each other according to the value of the relative basis for each commodity future;
applying a predetermined rule based on the ranking of the set of commodity futures to determine in which commodity futures of the set of futures a position is taken.

20. A method for creating a commodity futures index comprising the steps of:
identifying a set of at least two traded commodity futures;
determining a relative momentum for each commodity future;
ranking the set of commodity futures relative to each other according to the value of the relative basis for each commodity future;
applying a predetermined rule based on the ranking of the set of commodity futures to determine in which commodity futures of the set of commodity futures a position is taken.
